(19) United States
(12) Patent Application Publication
(10) Pub. No.: US 2013/0138491 A1
(43) Pub. Date: May 30, 2013

(54) QUICKLY VERIFIABLE PERSONALIZED INCENTIVES AND AUTO FULFILLMENT

(71) Applicants: Zeming M. Gao, Portland, OR (US); Pingyi Yan, Shenzhen (CN)

(72) Inventors: Zeming M. Gao, Portland, OR (US); Pingyi Yan, Shenzhen (CN)

(21) Appl. No.: 13/749,775

(22) Filed: Jan. 25, 2013

Related U.S. Application Data
(63) Continuation-in-part of application No. 13/563,689, filed on Jul. 31, 2012.
(60) Provisional application No. 61/513,602, filed on Jul. 31, 2011.

(51) Int. Cl. G06Q 30/02

(52) U.S. Cl. CPC G06Q 30/0225
USPC 705/14.23

(57) ABSTRACT

A networked business and consumer space is created in which consumers can interact with businesses. A verifiable identifier for each commercial item is used to create an actionable link between a consumer and a business, which can be a manufacturer, a marketer, or a retailer of the commercial item. The actionable link provides the basis for a complete loop of information during a transaction in which an incentive may be quickly and electronically verifiable. The method and the system reduce paperwork, increase transparency and efficiency, and further reduce error and fraud.

### RELATED APPLICATION

This application claims priority to U.S. Provisional application Ser. No. 13/563,689 filed on Jul. 31, 2012, entitled “Socially Networked Business & Consumer Space,” which is incorporated by reference herein in its entirety.

### BACKGROUND

The general consumer space is defined by various interactions including business-to-consumer, business-to-business, consumer-to-consumer, and consumer-to-business interactions. Various business models are defined by their characteristic embodiments of these interactions. Present business-to-consumer interactions, for example, generally include traditional retailing from an established merchant to a member of the consuming public. In this channel, many marketing methods including incentives such as coupons, rebates, credits, loyalty programs are used.

A common problem that exists in fulfilling incentives is the validity verification of the incentives. In a coupon process, for example, a vendor that collects a coupon has to submit the coupon with receipts to a coupon processing center, which verifies the validity of the coupon and authorizes a reimbursement. This leads to a slow, tedious, inefficient, wasteful, error-prone, and fraud prone process. A similar problem exists for rebates, in which the burden largely shifts from the retailer to retail consumers.

In addition, the existing marketing methods generally are geared to help retailers promoting sales to customers. Few channels and tools are available for a manufacturer to market directly to buyers. A manufacturer may either choose a direct sale channel, which usually has very limited reach without the help of the existing powerful retail ecosystem, or use manufacturer's rebates to attract retail customers. Rebates in their existing form, however, are unpopular because they place unreasonable burdens on retail consumers due to the lack of efficient purchase verification in the rebate fulfillment process.

A need exists for a system that can create, manage, and fulfill promotional incentives more effectively in order to create more direct and interactive manufacturer-buyer channels, and to create and enable personalized incentives.

### SUMMARY

This disclosure describes, in part, a networked business and consumer space. Within this space consumers can interact with businesses. A verifiable identifier for each product item is used to create an actionable link between a consumer and a business, which can be a manufacturer, a marketer, or a retailer of the product item. The actionable link provides a basis for a complete loop of information during a commercial transaction in which an incentive may be quickly and electronically verifiable without causing any delay. The method and the system reduce paperwork, increase transparency and efficiency, and further reduce error and fraud. Dynamic, controllable and transparent marketing campaign is enabled by establishing actionable links between the consumers and the business through verifiable item identifiers at any desirable precision up to the individual item level.

One embodiment is a method implemented on one or more computer systems for applying an incentive in a commercial transaction. The one or more computer systems include a server computer having an incentive module. The computer system associates a commercial item with an identifier, which is created to uniquely identify the commercial item among at least all commercial items active in the server computer during a desired operating period. The identifier may be affixed to or embedded in the commercial item or an accessory item associated therewith, and at least a portion of the identifier is covered from normal viewing and only conditionally revealed to an authorized party during or after the transaction. The incentive module establishes an incentive applicable to the commercial item. Subsequently, the server computer receives the identifier revealed to the authorized party, verifies the identifier and, responsive to successfully verifying the identifier, applies an incentive to the commercial item.

In another embodiment, the server computer receives augmented item information related to a commercial item from a point-of-sale, and generates an identifier of the commercial item. The identifier is created to uniquely identify the associated commercial item among at least all commercial items active in the server computer during a desired operating period. The server computer sends the identifier or a confirmation code thereof to a first application program running at or in connection to the point-of-sale, and subsequently receives the identifier or the confirmation code from a second application program running at or in connection to the point-of-sale. The server computer verifies the identifier, and responsive to successfully verifying the identifier or the confirmation code, applies an incentive to the commercial item.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 is an example architecture that shows interconnectivity between a consumer, a business, and server computers that facilitate incentive applications in a social space for interaction between businesses and consumers.

FIG. 2 is a block diagram of example components of the server computers of FIG. 1.

FIG. 3 is example contents of the data stores containing consumer accounts and business accounts from FIG. 1.

FIGS. 4A-4C are examples of an item identifier.

FIG. 5 is an example process for fulfilling an incentive to a consumer on behalf of a business.

FIG. 6 is an alternative to the example architecture of FIG. 1.

FIG. 7 is an example process for fulfilling an incentive to a consumer on behalf of a business using intangible identifier generated on-the-fly.

FIG. 8 is an example architecture of the intermediary account system.

FIG. 9 is an example process for affecting a personal price using a rebate mode.

FIG. 10 is a flow diagram of an example process for provisioning an incentive to a consumer by using a coupon.

FIG. 11 is a flow diagram of an example process for hybrid shopping with auto fulfillment of verifiable incentives.

### DETAILED DESCRIPTION

In this description, the order in which a process is described is not intended to be construed as a limitation, and any number of the described process blocks may be combined in any order to implement the method, or an alternate method.

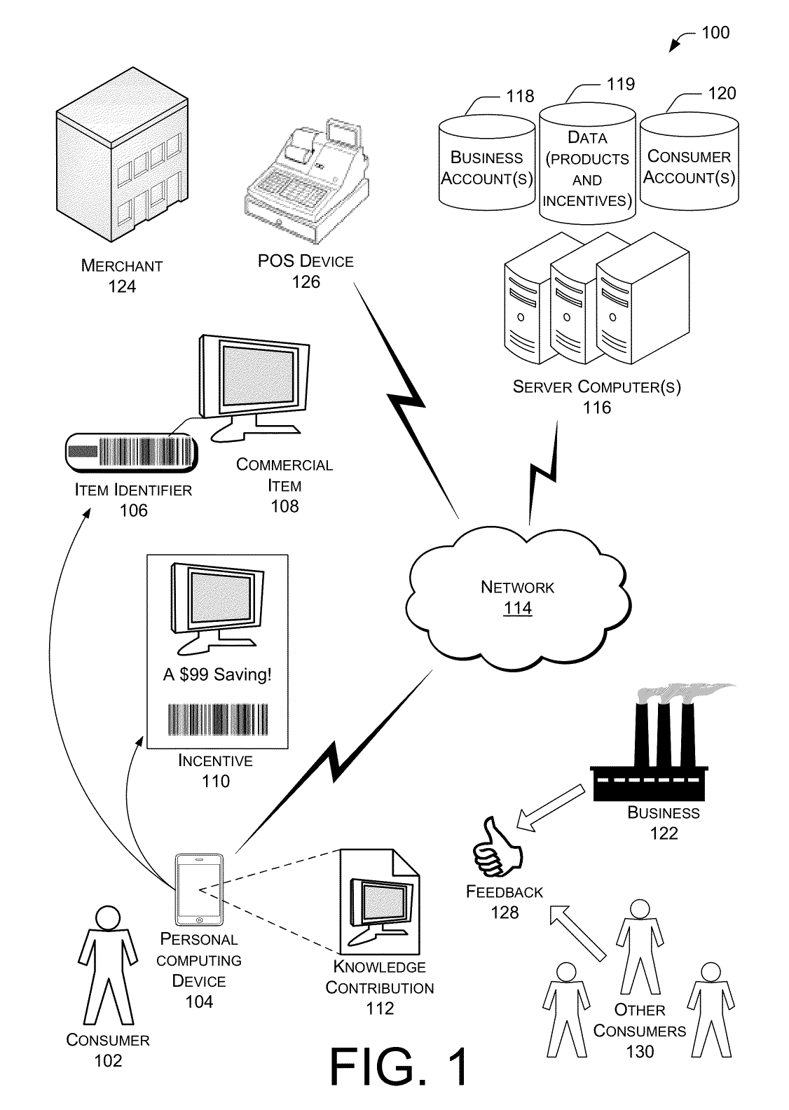

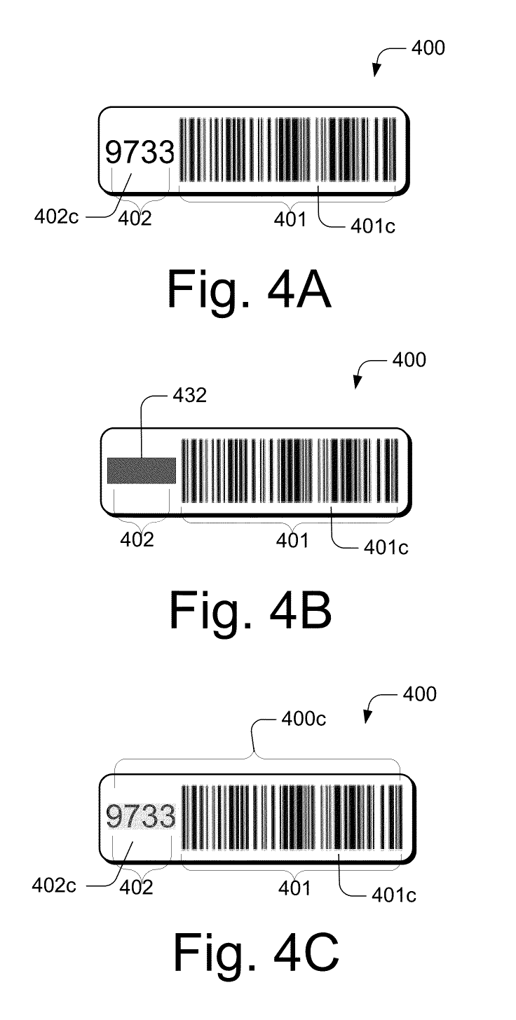

FIG. 1 is a schematic diagram of an illustrative architecture 100 that includes a consumer 102 and a personal computing device 104 of the consumer 102. The personal computing device 104 may be a mobile phone, a notebook computer, a netbook, a tablet computer, a personal digital assistant (PDA), an e-book reader, a digital media player, a personal gaming device, and the like. Also, the consumer 102 may have access to more than one personal computing device. For example, to perform online shopping at home, the consumer may use a PC to access the online shopping website, while using a mobile phone for the purpose of personal ID and item identifier verification. The personal computing device 104 may be used by the consumer 102 to scan an item identifier 106 attached to a commercial item 108. The item identifier 106 may include any type of machine-readable mechanism for representing information such as, a one, two, or three-dimensional barcode, a matrix barcode (e.g., quick response (QR) Code®), a radio frequency identification (RFID) tag, a near field communication (NFC) tag, and the like. The item identifier 106 may encode information representing the item 108 such as a product number for the commercial item 108. Detail and examples of identifier 106 are shown in FIG. 4. As used herein, “commercial item” refers to any type of good or service that may be sold or transacted including digital goods, virtual goods, software as a service, and combinations of goods and services.

The personal computing device 104 may read the item identifier 106 by using a built-in barcode scanner. Other types of tags or labels may be read by appropriate components in the personal computing device 104 such as an NFC device that receives a signal from an NFC target.

The personal computing device 104 may receive an incentive 110 which is applicable the item 108. The incentive 110 may be embodied in a tangible object such as a printed matter such as a poster, catalog, postcard, etc. But the incentive 110 may be electronic and may be displayed on a screen of the personal computing device 104, or another electronic display device such as a monitor or television.

In one embodiment, the incentive 110 is shown to the merchant 124 to be validated through POS device 126. An example of such incentive 010 is a coupon, which the merchant 124 receives, and accepts for redemption. A barcode may be included on an incentive 110 which encodes information that can be shown to the merchant 124 to the incentive 110 and allow the system to determining the validity with regard to the item 108. This however is optional if the incentive 110 is associated with an account of the consumer 102 because as long as the item identifier 106 and the account of the consumer 102 are communicated to and determined by the server computer 116, incentive 110 can be identified by the incentive module in the system, and its validity and applicability can be determined by the system.

In another embodiment, the incentive 110 is a rebate type discount which needs not to be shown to the merchant 124, but only displayed to the consumer 102 for information. As long as the purchase event is verified, and the item identifier 106 recognized by the incentive module in the system, the validity and the applicability of the incentive 110 may be determined by the system without even any awareness of the incentive 110 by the merchant 124.

The incentive 110 may have a random incentive value for marketing purpose. The incentive one 110 may also be a reward based on lottery with a winning number identified by the item identifier 106 which is preferably concealed before the item 108 is purchased.

Incentive 110 may be further personalized, with its incentive value and applicability determined by using a personalized score quantifying a contribution history and/or a loyalty history of the consumer acts in relation to a business which makes or markets the commercial item. The acts may include writing a user review about a product made or marketed by the business, receiving feedback on the user review, or purchasing a product made or marketed by the business, as illustrated further herein.

Depending on the type of incentive 110, whether it is a coupon, rebate or credit, the system may be designed to work with a suitable process. If the incentive 110 is a coupon, the consumer 102 purchases the item 108 at a discount price (regular price minus the coupon value), while the merchant 124 subsequently receives a coupon reimbursement from the business 122 that makes or markets the item 108 (e.g., the manufacturer, or an authorized marketer). If the incentive 110 is a rebate, the consumer 102 purchases the item 108 at a regular price, and subsequently receives a reimbursement of the rebate value from the business 122.

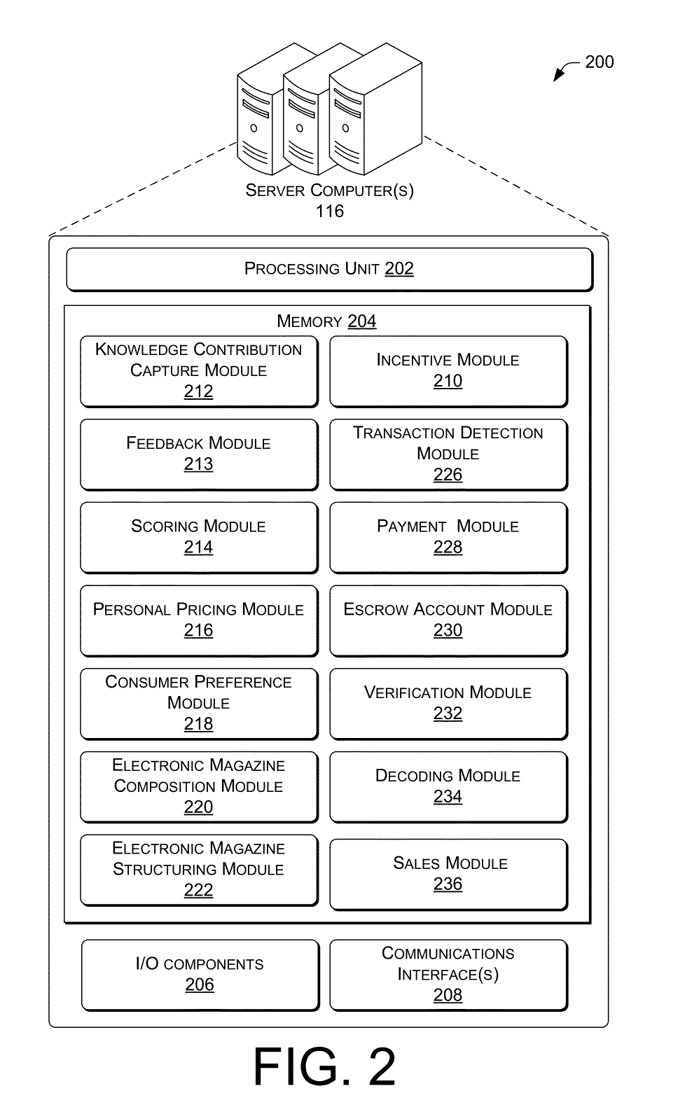

For example, if the incentive 110 is a coupon, as the consumer 102 presents the item 108 at the checkout of a point-of-sale, the POS device 126 scans the item identifier 106 and transmits the scanned information to server computer 116 through network 114. An incentive module 210 (FIG. 2) checks and verifies the identifier 106, and pending other confirmation requirements, may apply incentive 110 if it is valid with regard to the item 108 with verified identifier 106. When the identifier 106 is at least partially concealed from normal view and only reviewed at a time of purchase, receiving the verifiable item identifier 106 may serve as good enough evidence to prove the purchase event in order to apply the relevant incentive 110. In some embodiments, the identifier 106 has an item identification code and a concealed confirmation code. In this case, the item identification code may be first transmitted to server computer 116, which then requires POS device 126 or personal computing device 104 (depending on the design of the system) to enter the revealed confirmation code for further verification. However, additional confirmation requirements, such as a pending result of an audit or submission of a receipt, may be optionally imposed.

Alternatively, if the incentive 110 is a rebate, the consumer 102 may purchase the item 108 normally without any involvement of the POS device 126 in verifying the item identifier 106 with server computer 116, and subsequently obtain the identifier 106 from the item 108 that has just been purchased and submit it to the server computer 116 in order to have the incentive 110 verified and applied.

It should be noted that the POS device 126 is not limited to a traditional POS device illustrated in FIG. 1. Instead, the POS device 126 can be any type of POS suitable for checkout and payment at a point-of-sale. It may be a tablet computer device which has a POS application program installed thereupon. It may also be a cloud POS which has a POS application program running in the cloud, managed by the merchant 124 and accessible by the consumer 102. Similarly, the term “point-of-sale” refers to a location (physical or virtual) where the POS device 126 is placed, and may either be an off-line retail site or an online shopping site.

In addition, whether or not the consumer 102 makes a purchase, he or she may have other interactions with the item 108, the item identifier 106, and the incentive 110 for a better shopping experience. For example, as the consumer 102 interacts with items 108, incentives 110, and otherwise participates in the consumer and business space, the consumer 102 may create one or more knowledge contributions 112 with regard to one or more of items 108. The knowledge contributions can be product reviews, comparisons of similar items, how-to guides, product critiques with feature or new design suggestions, and the like. Knowledge contributions 112 can be created by using the personal computing device 104 or another computing device such as a desktop computer. The consumer 102 may create multiple knowledge contributions 112 about a single item as well as knowledge contributions about many different items. Each knowledge contribution 112 may be a review of an item, a discussion of the item's functionality, an explanation of how to use the item, a rating of the item, or the like. Knowledge contribution 112 may be presented as any type of digital data such as text, an audio file, a video file, or the like. For example, the consumer 102 may type a review of an item and create a knowledge contribution 112 in text form. Alternatively, the consumer 102 may create a recording of his or her voice describing some aspects of an item and that recording may be the knowledge contribution 112. Similarly, the consumer 102 may make a video about how to assemble an item and share that video as a knowledge contribution 112. It is noted that to make a knowledge contribution 112, the consumer 102 may log onto a dedicated website providing links to a variety of products to be reviewed or commented on. The consumer 102 may or may not be directed to the dedicated website by first interacting with items 108 or incentive 110.

The knowledge contributions 112 may be shared with others via a network 114. The consumers can access and view these knowledge contributions in order to gain the benefit of the knowledge from fellow consumers and to provide feedback on the knowledge contributions themselves. The personal computing device 104 may be connected to the network 114. The network 114 represents any type of communications network such as the Internet, a wide area network (WAN), a local area network (LAN), a telephone network, a cable network, a mesh network, a peer-to-peer network, and the like.

The server computer 116 is connected to the network 114 and communicates with the personal computing device 104 through the network 114. The server computer 116 may include one or more separate hardware devices or a distributed system of multiple pieces of computer hardware that provides the functionality of a server computer through a cloud computing implementation. The server computer 116 may support the socially networked business and consumer space by facilitating communication between various computing devices of the consumers and businesses. In some implementations, the server computer 116 may contain or otherwise have access to one or more business accounts 118, one or more consumer accounts 120, and data 119 containing information and records of products, individual product items 108 and incentives 110. Data 119 may be selectively accessible by, or included in, the business accounts 118 and consumer accounts 120. The business accounts 118 may include an account record for a business 122 that manufactures or is otherwise associated with the item 108. The business 122 may use its business account 118 to participate in the socially networked space by doing such things as reviewing knowledge contributions 112 of the consumer 102. The consumer 102 may have an account record in the consumer account 120 that contains information about the consumer 102 such as, for example, each of the consumer's knowledge contributions 112.

The business 122 may also provide a marketing policy applicable to the consumers 102, item 108, identifier 106 and incentive 110. For example, the marketing policy may include rules to determine the incentive value at least partially according to a range value of the identifiers 106.

In one embodiment, the marketing policy is dynamic and includes rules for determining the incentive value at least partially according to one or more of factors including a time of the commercial transaction, a cumulative number of transactions involving similar commercial items, geographic location of the transaction, and identity of one or more parties involved in the commercial transaction. In this manner, business 122 may have a control over marketing the product items 108 which have already been manufactured and placed in commerce. A marketing campaign can be designed to turn on and turn off certain incentives such as rebates with precision at various levels such as product model level, batch level, or even item level. In addition, because incentives 110 may be applied quickly or even in near real-time, the business 122 has a transparent view of the status of the marketing campaign, and may quickly adjust the marketing policy and its rules based on the feedback of the marketing campaign. All this is enabled by establishing an actionable link between the consumer 102 and the business 122 through the verifiable item identifier 106 at any desirable precision up to the individual item level.

A merchant 124 is used herein as an entity that provides the item 108 for sale to the consumer 102. The merchant 124 may also be called a retailer or retail-outlet. Some merchants 124 operate brick-and-mortar sores and may use a point-of-sale (POS) device 126 to process transactions with the consumer 102. In some implementations, the POS device 126 may be connected to the network 114. Thus, the POS device 126 may receive information from the server computer 116 based on data 119 related to the business accounts 118 and/or the consumer accounts 120. Information received by the POS device 126 from the server computer 116 may be used to verify or modify an aspect of a transaction between the merchant 124 and the consumer 102.

In other implementations the merchant 124 may be an online merchant and the computers used to implement the e-commerce storefront for the merchant 124 may communicate with the sever computer 116 over the network 114. In this case, there are multiple optional designs of the process of applying incentive 110.

In one option, the item identifier 106 is created prior to the transaction of selling and buying the item 108 and physically attached to or embedded in the item 108. The consumer 102 may purchase the item 108 in a way similar to common online shopping, but submit the revealed item identifier 106 to the server computer 116 through personal computing device 104 after the consumer 102 has received the item 108 shipped from the merchant 124. Upon verification of the item identifier 106 and the incentive 110's applicability to the item 108, the incentive module 210 on the server computer 116 applies the incentive 110 to the item 108 in connection with the account 120 of the consumer 102. This process is suitable for marketing the item 108 when the incentive 110 is a rebate from the manufacturer (e.g., business 122) which is separate from the merchant 124.

In an alternative to the above option, the merchant 124 obtains the item identifier 106 before shipping the item 108, and submit the item identifier 106 to the server computer 116 through a merchant computer (not shown) accessible by the merchant 124. Upon verification of the item identifier 106 and the incentive 110's applicability to the item 108, that incentive module 210 on the server computer 116 applies the incentive 110 to the item 108 in connection with the account 120 of the merchant 124. This process is suitable for marketing the item 108 when the incentive 110 is a coupon issued from the manufacturer (e.g., business 122) which is separate from the merchant 124.

In yet another option, the item identifier 106 is not embodied on a physical tag or label, but rather a digital identifier generated on-the-fly during the transaction. As described herein, in this mode, the product information related to item 108 and additional information (such as the geographic location of the point-of-sale, IP address of the consumer 102, and the time of the transaction) are combined for the server computer 116 to generate a unique item identifier 106, which can be used for validating the incentive 110.

For example, if the incentive 110 is a coupon, the server computer 116 may verify the validity and applicability of the coupon with regard to the consumer 102, and reimburse the merchant 124 the coupon value instantly. The server computer 116 may require further evidence such as a proof that a transaction is complete and a payment has been made before reimburse the merchant 124, and such further evidence may be done through communications between the POS device 126 and the server computer 116 instantly without waiting for the receipt submission through a coupon clearinghouse. In many cases, such communication may occur indirectly through a payment gateway, but such detail does not have a bearing on the essence of the processes described herein. The dynamically generated item identifier 106, being unique to the item 108, may be used for further bookkeeping and accounting purpose by the merchant 124 and the business 122.

If the incentive 110 is a rebate, the incentive 110 may be verified with the consumer 102 by communicating the item identifier 106 or a consummation code thereof through personal computing device 104 to the consumer 102, and requiring the identifier 106 or the confirmation code to be returned to the server computer 116 for verification. In an example process, server computer 116 detects the identity of the consumer 102, and sends the identifier 106 or the confirmation code to a mobile phone number registered with the account the consumer 102, and asks the consumer 102 to return the identifier 106 or the confirmation code for verification.

The consumer 102 may be incentivized to provide the knowledge contribution 112 by receiving a monetary benefit from the business 122. By acting as a product reviewer or tester, the consumer may be thought of as a micro-employee of a business which designs, makes, markets, distributes, or retails the product reviewed by the consumer. The business may or may not be a merchant that retails the product. The incentive could be in the form of a cash payment, a coupon, a rebate, or the like. In some implementations, consumers are scored by the business and each consumer receives personal pricing or a personal incentive to effectuate personal pricing for items sold by the merchant. Each consumer may receive his or her own price based on their respective scores. The price for the same item may be different for different consumers based on the respective quality and quantity of knowledge contributions. Thus, personal pricing can provide compensation commensurate with participation in the social community thereby incentivizing the creation of valuable knowledge contributions.

The personal pricing may be based on feedback 128 received on the consumer's knowledge contributions 112. The feedback 128 may include a review or rating of the knowledge contribution 112 that indicates what a business 128 or other consumers 130 thought of the knowledge contribution 112. Consumers that provide high-quality and well reviewed knowledge contributions may receive more favorable personal pricing that the consumers that only provide superficial knowledge contributions. The business 128 that provides the feedback 128 may be the business 128 that manufactures, markets, distributes, promotes, or is otherwise connected with the item 108 that is the subject of the knowledge contribution 112. Thus, the business 128 may review the review of its product. In some implementations, the business 128 may be the same as the merchant 124. In other implementations, the business 128 may be a manufacturer of the item 108 and the merchant 124 may be the brick-and-mortar or online retailer.

The other consumers 130 may be members of the socially networked space and some or all of them may have respective consumer accounts 120. By providing feedback on each other's knowledge contributions 112 the various consumers in this social network strengthen their ties to one another and can develop trust relationships and productive collaborations. Since the merchants 122 and businesses 128 are also part of this network, and there is two-way communication between consumers and merchants. The businesses 128 and merchants 122 also become part of the social network and foster productive interactions with the consumers.

FIG. 2 is a schematic representation 200 showing example components of the server computer 116 introduced in FIG. 1. The server computer 116 may include a processing unit 202. The processing unit 202 represents one or more hardware processors each implemented with a single or multiple core design. Thus, the processing unit 202 may be implemented as a plurality of separate processors that function together as a unit to process instructions. The server computer 116 also includes memory 204. In some implementations, the memory 204 may be implemented in hardware or firmware. The memory 204 may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a processing unit. The memory 204 encompasses computer-readable storage media which is non-transitory media that is capable of storing information such as computer instructions in formats other than transitory signals. The memory 204 may contain an operating system for controlling modules within the memory 204 as well as hardware of the server computer 116.

Input and output (I/O) components 206 are one type of hardware that may be a part of the server computer 116. The I/O components 206 may include such things as monitors, keyboards, mice, speakers, printers, and the like. The server computer 116 may also include one or more communication interfaces 208 for receiving and sending information. The communication interfaces 208 may communicatively couple the server computer 116 to a communications network, such as network 114, using any conventional networking protocol or technology.

The memory 204 includes multiple modules such as, but not limited to, an incentive module 210, a knowledge contribution capture module 212, a feedback module 213, a scoring module 214, a personal pricing module 216, a consumer preference module 218, an electronic magazine composition module 220, an electronic magazine structuring module 222, a transaction detection module 226, a payment module 228, an escrow account module 230, a verification module 232, a decoding module 234, and a sales module 236. Each of these modules will be described in greater detail below. The server computer 116 may also include additional modules within the memory 204 and/or hardware components other than those described herein.

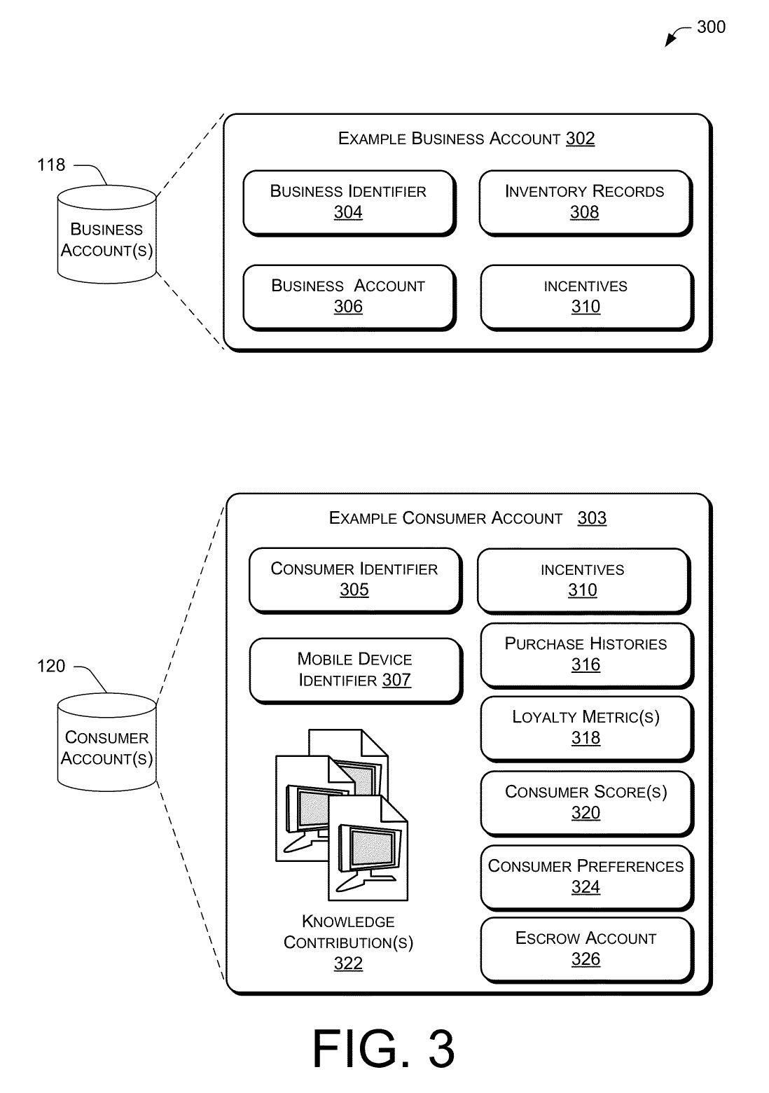

FIG. 3 shows example contents of the business accounts 118 and the consumer accounts 120. The server computer 116 may contain or be connected to a data store that includes the plurality of business accounts 118. An example business account 302 may include a business identifier 304 that uniquely identifies and differentiates one particular business from other businesses participating in this social space. The business identifier 304 may be a name of the business, a numerical or alphanumerical code assigned to the business, or any other type of unique identifier. A business account 306 in the example business account 302 may pay out funds to a merchant or consumer as compensation for a coupon or rebate. The example business account 302 may also include inventory records 308 showing which items are associated with the business. The inventory records 308 may identify items that are available for sale from a brick-and-mortar location as well as items that are available to be shipped to a consumer either directly from the business or from another merchant. The inventory records 308 may include an inventory of items associated with respective item identifiers. Specifically, the inventory records 308 may include item identifiers that are associated with the items in the inventory. The business account 302 also includes incentives 310, such as coupons, rebates, credits and personalized pricing incentives. The incentives 310 may be generic, item specific, or consumer specific. Consumers may also save desirable incentives 310 into consumer accounts 120.

The consumer accounts 120 may also be stored in a data store that is part of or connected to the server computer 116. One example consumer account 303 representing an account of the consumer 102 from FIG. 1 is discussed herein. The example consumer account 303 may include a consumer identifier 305. The consumer identifier 305 may be the name of the person who is the consumer or another unique number or code identifying that person. The consumer may be associated with one or more mobile devices and a mobile device identifier 307 for each of those mobile devices may be stored in the consumer account 303. The mobile device identifier 307 may be a phone number, a device serial number, a subscriber identity module (SIM) card number, or other unique identifier of a mobile device. In this example, the mobile device identifier 307 may identify the personal computing device 104 introduced in FIG. 1. Storing the mobile device identifier 307 as part of the consumer account 303 allows for identification of the consumer when the corresponding mobile device is used to facilitate a transaction or scan of a tag.

The consumer may have saved some desirable incentives 310 issued or authorized by the business accounts 118. Such desirable incentives 310 may also be automatically pushed to the consumer account 303 based on the consumer preferences 324 and purchase histories 316, and consumer scores 320. The desirable incentives 310 are searchable and viewable by the consumer who has logged on to the consumer account 303, or may also be pushed to the personal computing device 104 (such as a mobile phone) to be displayed automatically, alone or in a group with other incentives and information.

Past purchase histories 316 of the consumer relative to different merchants, business, and brands may be stored in the consumer account 303. One or more loyalty metrics 318 may be derived from the purchase histories 316. The loyalty metrics 318 may be based on a number of items purchased, a total value of items purchased, a temporal frequency of purchases, or any other quantifiable characteristic that may be obtained from the purchase histories 316 and used to determine the relative strength of preference a consumer has for a particular brand, manufacture, business, merchant, etc. A consumer score or scores 320 may also be stored in the example consumer account 303. The consumer scores 320 may be based on feedback received on knowledge contributions made by the consumer. A consumer may have multiple consumer scores 320 each associated with a different item, item category, business, merchant, brand, etc. Thus, a particular consumer score 320 may be narrowly focused to represent that consumer's contribution, knowledge, loyalty, with respect to a particular item or class of items.

The example consumer account 303 may also include knowledge contributions 322 made by the consumer. A consumer may create any number of knowledge contributions 322. Each knowledge contribution 322 may be associated with a particular product, brand, business, merchant, etc. The server computer 116 may make the knowledge contributions 322 of the respective consumers available for searching, viewing, and access by other consumers and businesses. In some implementations, when a knowledge contribution 322 about a particular item is received, that knowledge contribution 322 may be automatically sent to the respective merchant or business associated with the particular item. This way, businesses may readily stay informed of relevant knowledge contributions 322.

Each consumer may not only provide knowledge contributions 322 but also read or view the knowledge contributions made by other consumers. As part of techniques used to surface the most relevant knowledge contributions to the consumer, consumer preferences 324 may be part of the example consumer account 303. The consumer preferences 324 may indicate which types of knowledge contributions interest this particular consumer. For example, the consumer preferences 324 may indicate that the consumer is interested in cooking and knowledge contributions about cooking or items used for cooking. Similarly, the consumer preferences 324 may indicate that consumer has favorite authors (e.g., other consumers) of knowledge contributions. Additionally, the consumer preferences 324 may show that the consumer likes particular brands, particular places, particular categories of items, and the like. Knowledge contributions that discuss those brands, places, etc. may be treated as preferred content for this consumer.

Additionally, the example consumer account 303 may include an escrow account 326 for the consumer. The escrow account 326 for the consumer may receive funds from the business account 306 shortly after the consumer submits a rebate or after the merchant submits a coupon. Money in this escrow account 326 may be released to the consumer or the merchant once satisfactory confirmation of the transaction and payment has been received.

### Knowledge Contributions and Personal Incentives

This disclosure describes, in part, techniques for incentivizing, capturing, and commercializing productive energy of consumers. When making purchases, consumers spend not only money but also time and resources researching and evaluating the items that they purchase. Consumers that have purchased an item are able to provide information on their experiences and on the quality of the item. However, much of this knowledge is not captured because it stays with the individual consumers and is not shared in a social space where the knowledge can be accessed and used by others.

Consumers may provide knowledge contributions to reflect their respective knowledge and experiences with different items. Businesses may provide personal incentives to encourage the consumers to provide knowledge contributions. Merchants and businesses may also review knowledge contributions to provide feedback to the consumer who made the knowledge contribution. The knowledge contributions and the corresponding reviews about the knowledge contribution creates a feedback loop between consumers, business, and merchants. Thus, consumer-to-business interactions can become a meaningful part of this social network due to the presence of feedback.

Returning to FIG. 2, several modules from the memory 204 of the server computer 116 are of particular relevance to capturing knowledge contributions and determining personal incentives. For example, the knowledge contribution capture module 212 captures a knowledge contribution made by a consumer about an item. The knowledge contribution capture module 212 may receive an indication of an item, such as a unique item identifier, and a knowledge contribution about the item. The knowledge contribution may be any format such as a text file, an audio file, a video file, and the like. The knowledge contribution may be received from, for example, the personal computing device 104 of the consumer 102. In some implementations the knowledge contribution, once captured, may be stored in a consumer account as shown in FIG. 3.

The feedback module 213 may receive feedback on the knowledge contribution. The feedback may be received from a business, a merchant, or peer feedback from one or more other consumers. Multiple feedbacks may be received from multiple sources and ratings or other metrics may be computed across all of the different sources of feedback. Thus, a given knowledge contribution may have a score or a rank derived from the feedback provided by a plurality of sources. In some implementations, the businesses which provide feedback may be limited to only those businesses or merchants that are associated with the item discussed in the knowledge contribution. Thus, the business providing feedback may be a business or merchant that designs, makes, markets, distributes, or retails the item.

The scoring module 214 may quantify a score for the consumer based on past actions of the consumer. The past actions may include actions that represent loyalty or preference for a particular brand or manufacturer of items. In such instances, the scoring module 214 may generate a loyalty metric for the consumer based on a purchase history of the consumer. The loyalty metric may be store in a consumer account of the consumer as shown in FIG. 3.

The past actions may also include generation of knowledge contributions. In some implementations, the score may be based simply on a number of knowledge contributions. In other implementations, the score for the consumer may be based on the feedback received for that consumer's knowledge contributions. Thus, positive feedback for knowledge contributions may result in an improved score as compared to no feedback or negative feedback. The scoring module 214 may quantify the score for the consumer based any one or combination of feedback from businesses, the peer feedback from other consumers, and the loyalty metric of the consumer.

The personal pricing module 216 may calculate a personal incentive for the consumer on an item sold by a business. The personal incentive may be specific to the consumer. In some implementations the personal incentive is a function of the consumer's score as determined by the scoring module 214. For example, a higher score may lead to a more valuable personal incentive. The personal incentive may be a personal price that can be achieved by subtracting a discount amount from on a base price of the item. The personal price may be provided to the consumer by giving the consumer a credit or a rebate to reimburse the consumer for paying a higher price than the personal price. In other implementations, the personal pricing may be achieved by providing the consumer with a coupon that can be used to reduce the purchase price of the item at the time the consumer purchases the item.

As well as being consumer specific, the personal pricing may also be item specific. For example, a consumer that has provided a large number of knowledge contributions related to an item that belongs to a particular item category may receive low personal prices for other items in the same item category. However, the consumer may not receive any discount for items in different categories for which he or she has not provided knowledge contributions.

Various ways exist to fulfill the personal pricing through a sales channel. The personal pricing may be translated to and represented by the personalized incentive 110 which may be a coupon, a rebate, or a credit, and fulfilled using a process described herein. The use of a verifiable item identifier in accordance with the present application enables quickly verifiable incentives to be automatically fulfilled without having to go through a traditional rebate or coupon process which is tedious, lengthy, and error and fraud prone.

### The Verifiable Item Identifier

In one embodiment, the item identifier 106 is a code created to uniquely identify the associated commercial item among at least all commercial items active in the server computer during a desired operating period (e.g., a day, a week, a month, a year, or longer). The identifier 106 may be affixed to or embedded in the commercial item 108 or an accessory item associated therewith, wherein at least a portion of the identifier 106 is covered from normal viewing and only conditionally revealed to an authorized party during or after a commercial transaction. For example, at least part of the code of identifier 106 may be covered by a removable material and only readable after the removable material has been removed. Alternatively, the entire identifier 106 may be concealed within the item 108 or within a package of the item 108 such that only the person has authorized access to the item 108 may open the concealment and to review the identifier 106.

In one embodiment, the identifier 106 includes an item identification code and a confirmation code, where the confirmation code is included in a covert portion of the identifier and, when revealed, is usable for confirming the item identification code. For example, the system maintains records of each item identification code and its correct confirmation code (which is, preferably, though not required to be, unique to each item identification code). For each item identification code that is being communicated to the system to verify, the corresponding confirmation code is required for verification. The item identification code may be a long code (e.g., 12, 16, 20 or more alphanumerical digits), but the confirmation code is preferably short (e.g., 1 to 6 alphanumerical digits).

The identifier 106 (whether or not divided to an item identification code and a confirmation code) may be a single code generated at once, and the complete identifier 106 may serve to uniquely identify the commercial item 108. Alternatively, the item identification code (e.g., the longer code) and the confirmation code (e.g., the shorter code) are two separate codes generated individually, such that the item identification code itself serves to uniquely identify the commercial item 108, while the confirmation code serves to confirm the item identification code.

The identifier 106, or the item identification code portion thereof, may be a structured code including multiple code segments each designated to a particular type of product information, such as company/enterprise identification, industry type information, product classification (food, drugs, cosmetics, clothing, electronics etc.), product category, date information (the date of code generation and/or the date of production), product serial number, and packaging tier information (from large container to medium boxes, cartons, smaller boxes and individual items). The identifier 106 may also contain a check digit for the purpose of error detection. For products in the international commerce, it may further have a code segment for country/region information. The identifier 106 may be created systematically using a systemwide internal standard, an external national standard or even an external international standard such as that promoted by EPCglobal.

Unless an external standard is adopted, the identifier 106 or the item identification code portion thereof can be any type of a code that is sufficient to identify the product. What is sufficient may be determined by the need. Different manufacturers or different products may need various levels of product identification. At a very low level, the identifier 106 may only be able to identify a certain product type or model. But in order to offer sufficiently effective systemwide uniqueness, higher level of specificity of the product identification is preferred. For example, the product code may uniquely identify a production batch of the same product, and may further uniquely identify a package of the same product, and still further may uniquely identify each separate item as an individual piece. If the manufacturer, or an authorized marketer, participates in a standard body for mass serialization, the identifier created and assigned may not only be item-specific among other product items of the same manufacture or the same industry, but may also be item-specific among all product items in the commerce that participate in the mass serialization standard.

The identifiers 106 or the item identification codes thereof may be generated individually or in groups (e.g. for a batch production of a certain product). The system may be designed to automatically generate the product-identifying codes as the manufacturer provides the product information online.

The structured codes as described above may be used as the final identifiers or the final item identification codes thereof to be embodied on the product items. As an alternative, another set of codes with less apparent structure may be generated based on the structure codes to be used as the final identifiers or the final item identification codes thereof instead.

As another alternative, non-structured codes may be generated without a predecessor code such as a structured code and used as the final item identifiers. For example, a non-structured code may be generated from raw product information, or simply generated by the system without any product information first and subsequently associated with a product item).

By the same token, the shorter confirmation code of the item identification code in the identifier may be computed from the longer item identification code.

Various schemes of code transformation, including hashing, encryption, or compression may be used to generate a corresponding set of item identifiers or item identification codes thereof from input information, such as the preceding structured codes or rock product information. For example, a hash function may be used to compute a shorter (e.g., 16 digits) and less structured (without distinctive code segments) code from a longer (e.g. 25 digits) structured code. The computation algorithm may preferably guarantee a one-to-one correspondence between the shorter and less structured codes and the longer structured codes, in order that the resultant product-identifying code may still have the level of specificity of the original structured code. The shorter code has the advantage of being easier to store and easier to be embodied by an authorized party yet more difficult to mass reconstruct by an unauthorized party.

When it comes to item identification as described herein, what matters is not an academic impossibility, but instead a practical burden on the potential defrauders. Perfect hashing is not required.

It is appreciated that the identifier 106 may be embodied in an human-readable form, such as plain numbers or alphanumerical combinations, but may also be embodied in a machine-readable form such as information that is only visible to special readers (either non-encoded or encoded), or encoded information that requires a special reader with a matching decoder to read. It is also appreciated that the identifier 106 may be any of a linear code such as a 1D barcode, a 2-D (matrix) code such as QR codes and Microsoft Tags, RFID code, or electric code readable using a NFC reader.

FIGS. 4A-4C show an example of an item identifier 106. The example item identifier 400 uses a mix of a barcode and an alphanumerical code. The mixed code item identifier 400 has a barcode 401c printed in a first code area 401, and a plain alphanumerical code 402c in the second area 402. The alphanumerical code 402c is to be concealed (FIG. 4B) when the associated item 108 is packaged and not normally viewable until the item 108 is purchased by the consumer 102 who may be authorized to uncover the numerical code 402c (FIG. 4C).

FIG. 4B shows the mixed code item identifier 400 when it is embodied on the product item (e.g., item 104). The confirmation code 402c in the confirmation code area 402 is concealed using a concealment (e.g., scratch-off material) 442. The barcode 401c is still uncovered and can be read using a barcode scanner.

FIG. 4C shows the mixed code item identifier 400 after the concealment 442 has been removed to reveal the numerical code 402c.

In the above embodiment, the barcode 401c alone may serve as a product-identifying code and be used to identify the product. The level of identification may have a desired specificity such as an individual product item level. The numerical code 402c is added to serve as a confirmation code to verify the product-identifying barcode 401c.

In one embodiment, the identifier 400 including both the barcode 401c and the alphanumerical code 402c is a single code generated at once using a suitable algorithm, and used as a whole to uniquely identify the associated item 108. The identifier 400 may be self-verifiable when both codes are submitted. In another embodiment, the barcode 401c and the alphanumerical code 402c are two codes generated separately, where the barcode 401c is generated using a suitable algorithm to be used alone to uniquely identify the associated item 108, while the numerical code 402c is generated and assigned to be a confirmation code (key) to verify the barcode 401c. The alphanumerical code 402c may be computed using an algorithm from the barcode 401c, or created separately (e.g., as a random number) and assigned to the barcode 401c.

The barcode 401c may be read using a barcode scanner. The barcode 401c may be a typical barcode code containing encoded information to identify an associated product item. The alphanumerical code 402c may either be human-readable or machine-readable. However, any combination may be used. In other embodiments, the barcode 401c may replace by a plain human-readable alphanumerical code, a 2-D barcode, RFID, or electric code readable using a NFC reader.

Furthermore, item identification code (the barcode 401c) and the confirmation code (alphanumerical code 402c) may be positioned differently in relation to each other, unlike the side-by-side arrangement as shown in FIGS. 4A-4C. For example, the item identification code may be placed in one area of the item 108, while the confirmation code may be placed in a separate area of the item 108. Regardless of its outer appearance, the integrity and internal association of the item identifier 106 (e.g., example identifier 400) is maintained in the database of data 119 in the server computer 116.

Preferably, the item identification code has a sufficient length (such as 16 alphanumerical digits or above) as a mass identifier to uniquely identify, while the confirmation code is relatively short (e.g., 6 alphanumerical digits or less) for convenient verification.

More examples of item identifiers are disclosed in U.S. patent application Ser. Nos. 13/079,022, 13/079,024, 13/118,605, all entitled “ANTI-COUNTERFEITING MARKING WITH ASYMMETRICAL CONCEALMENT” which are each fully incorporated herein by reference.

In some implementations, the item identifier 106 (example identifier 400) is created and attached to the item through packaging by the manufacturer. If the identity of the manufacturer is verified, the item identifier 106 may also be used as an anti-counterfeiting code to verify that the item 108 is indeed made by the manufacturer.

In other implementations, the item identifier 106 (example identifier 400) is created when the item 108 is already in commerce for marketing purpose. In this case, the incentive 110 may still be used the same way as described above, as long as the server computer 116 has a record of the identifier 106 in proper association with the item 108 and the incentive 110.

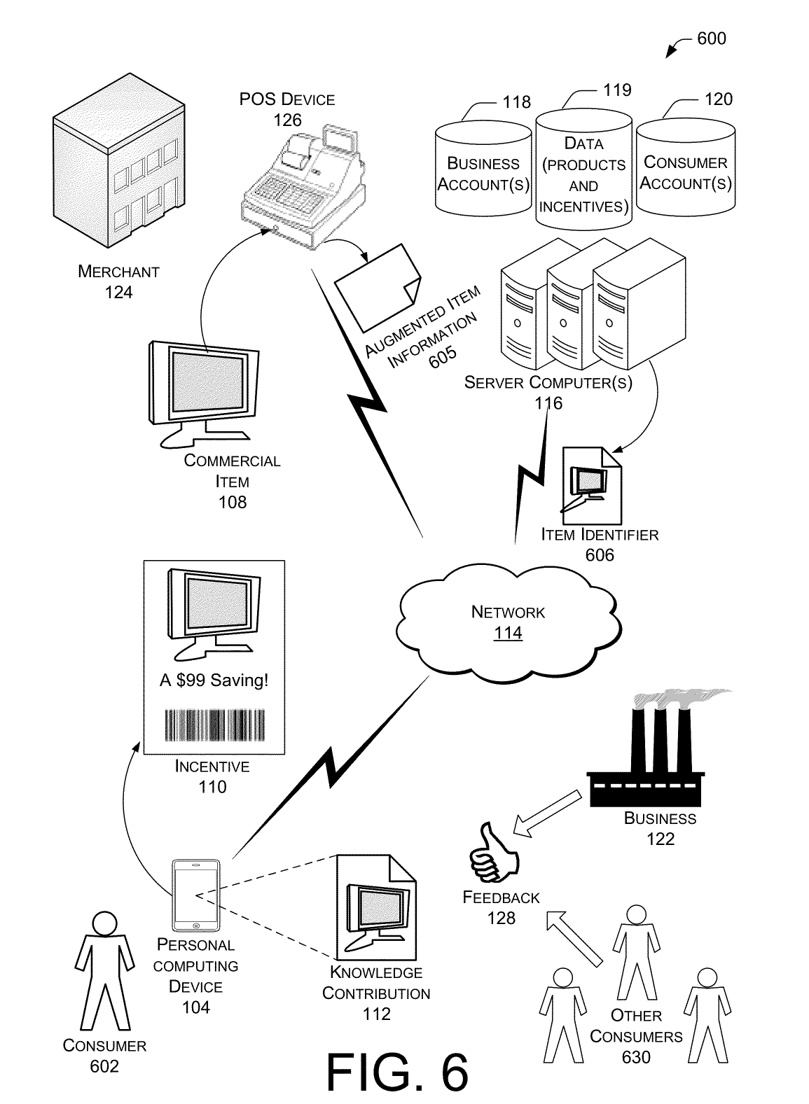

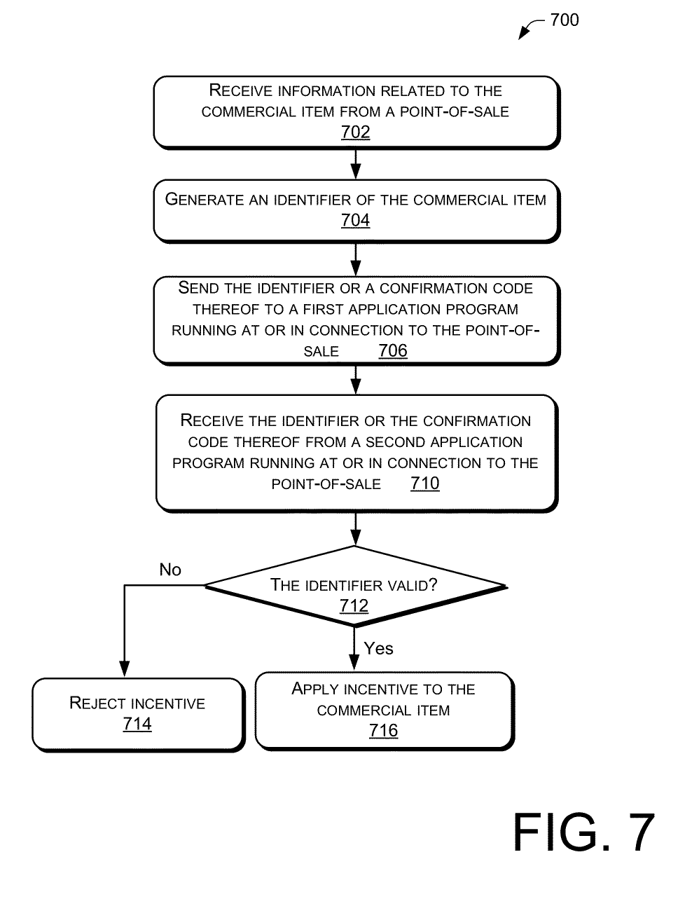

In an alternative embodiment 1 (detail in FIGS. 6-7), the item identifier 106 is created on-the-fly during checkout by using the POS device 126 communicating with the server computer 116. For example, as the POS device 126 scans a regular UPC code (not shown) of the item 108, it acquires and transmits the information related to the item 108 through the network 114 to server computer 116, which then generates the item identifier 106 based on the information received, and sends the identifier 106 (or a confirmation code thereof) back to either the POS device 126 or the personal computing device 104 (depending on the design of the incentive fulfillment process) for verification. Although a regular UPC code can only identify the item 108 to the product kind level (i.e., all items of the same product may have the same UPC code), additional information such as the geographic location of the POS device 126, the geographic location of the personal computing device 104, the IP address of the personal computing device 104, and the time of scanning or transmission may be used along with the regular UPC code to generate a more unique identifier 106 which can specify the item 108 individually at the item level.

### Incentive Fulfillment Process

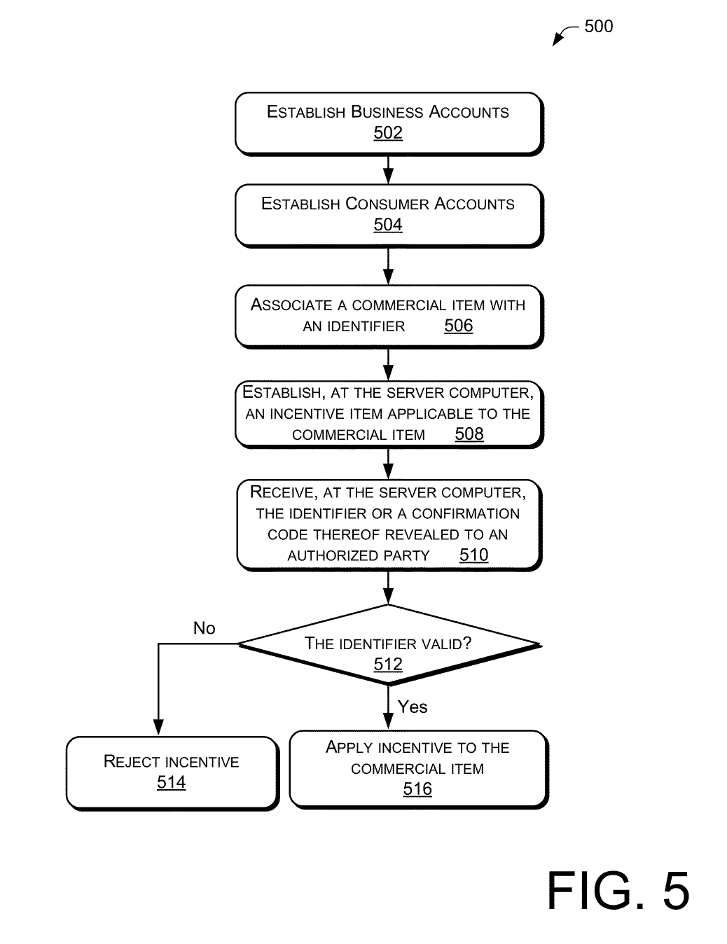

FIG. 5 shows an example process 500 for fulfilling an incentive to a consumer on behalf of a business. The process 500 is implemented on one or more computer systems for applying an incentive in a commercial transaction. The one or more computer systems including a server computer 116 which has an incentive module 210.

At 502, multiple business accounts are established for multiple businesses. Each of the multiple businesses may sell items to one or more consumers. The business accounts may be the same or similar to the business accounts 118 shown in FIG. 3.

At 504, multiple consumer accounts are established for multiple consumers. Each of the multiple consumers may buy items from one or more businesses. The consumer accounts may be the same or similar to the consumer accounts 120 shown in FIG. 3.

The purchasing of the item may be carried out in a variety of ways through a different point of sale. A registered consumer may buy a commercial item at a brick-and-mortar retail store, an online shopping website of one or more registered businesses, a hybrid shopping site combining off-line and online ordering, or an online shopping website supported by the sales module 236 of the server computer 116 which also has an incentive module 210. The point of sale may or may not be connected to the incentive center, and when connected may or may not be fully integrated in the same system.

At 506, the server computer 116 associates a commercial item 108 with an identifier 106. The item identifier 106 is created to uniquely identify the commercial item among at least all commercial items active in the server computer during a desired operating period. In an example implementation, the server computer 116 first receives information related to the commercial item 108 from a business entity making, supplying, marketing or selling the commercial item, and generates the identifier 106 of the commercial item 108 based on the received information. An algorithm may be used to systematically generate such product identifiers in mass quantities, to ensure the identifiers' ability to uniquely identify the associated commercial items at an individual item level. The server computer 116 then sends the item identifier 106 to the business or a receiving end authorized by the business, where the identifier 106 is affixed to or embedded in the commercial item 108 or an accessory item associated therewith. It should be noted that the identifier 106 may be sent to the business or the authorized party in a variety of ways. It may be first embodied (e.g., printed) in a physical tag or label, which then be shipped to the business or the authorized party. It may also be transmitted to the business or the authorized party digitally and be embodied on or in the commercial item 108 by the business or the authorized party.

The embodiment of the identifier 106 may be done in any practical way. In general, however, the embodied identifier 106 should preferably not be easily removed without causing a detectable and hard-to-recover damage or change to the embodied identifier 106 and/or the item 108 itself. If the item 108 is contained in a packaging such as a box or a bottle, it is also generally preferred that the item 108 contained in the packaging cannot be easily removed from the packaging without causing a detectable damage or change to the identifier 106.

The identifier 106 may be printed or embedded on a separate label or tag of a suitable material and affixed to the product, but may also be printed or embedded on the item itself if practical. In the present description, the term “tag” or “label” may refer to any of these situations and does not suggest that the tag or label is a physically separated or separable item from the commercial item 108. It is noted that embodying the identifier 106 on the item 108 does not mean that the item 108 is necessarily made first, and the identifier 106 embodied on the item 108 subsequently. The item 108 and the identifier 106 may be made in a single manufacturing process.

In one embodiment, at least a portion of the identifier 106 is covered from normal viewing and only conditionally revealed to an authorized party during or after the commercial item 108 has been sold. The concealed verification code 202c is conditionally revealed to an authorized person. The conditional revealing of the verification code 202c generally requires physical access to the product. It also requires the concealment over the verification code 202c to be at least partially invasively removed to uncover the concealed verification code 202c on the product. In the illustrated embodiment, the concealment is a scratch-off layer 232. As the authorized person gains physical access to the product, he may be allowed to manually remove the scratch-off layer 232 to reveal the verification code 202c.

The portion of the identifier covered from normal viewing may be designed to be only conditionally revealed by causing an irreversible change to the commercial item or the accessory item. The change is preferably visible to human without assistance of a special tool. An example of such characteristics is a scratch off material. When the identifier 106 includes an item identification code and a confirmation code, the confirmation code may be included in a covert portion of the identifier while the item identification code is left overt and readily readable. The confirmation code, when revealed, is usable for confirming the item identification code.

At 508, the inventive module 210 establishes an incentive 110 having an incentive value applicable to the commercial item 108. Because the inventive module 210 has access to not only general product information of the item 108 but also the specific item identifier 106 associated therewith, it has much control and precision in establishing incentive 110. The incentive 110 may be established, turned on and off any time with various precision at product kind level, patch level, or even item specific level. Typically, the incentive 110 may be created based on a rule which describes a certain range of identifiers to which the incentive 110 is applicable, and a time period during which the incentive 110 is active and valid.

The server computer 116 may apply a marketing policy to generate the identifier 106, and also to verify the identifier 106 upon receiving it. The marketing policy may be provided by the business entity or an authorized marketer that makes or sells the item 108, or formulated by certain general guidelines and rules established for the operation of the incentive module 210. An example marketing policy may include rules to determine the incentive value at least partially according to a range value of the identifier. Examples of a range value include all identifiers of the items made in one or more batches, all identifiers of the items made in a certain factory, all identifiers of the items which are a certain kind of product, all identifiers of the items which are made in a certain period of time, etc., or any combination of the foregoing.

In one embodiment, the marketing policy is dynamic including rules for determining the incentive value at least partially according to one or more of factors including time of the commercial transaction, a cumulative number of transactions involving similar commercial items, geographic location of the transaction, and identity of one or more parties involved in the commercial transaction. This allows flexible dynamic marketing. In the prior art methods, once a product is shipped from the manufacturer, there exists very little control over the shipped product items by the manufacturer or the marketer. With the help of an actionable link established between the manufacturer and the product items through verifiable item identifiers 106 and a centralized product/incentive management system, the manufacturer and/or the marketer may have a clear and real time picture of the sales of each product and the application and the output of the incentives, and may adjust the incentive policy based on the sales feedback. For example, a manufacturer may announce a manufacturer rebate on a certain product. Instead of setting a fixed date of expiration, the manufacturer may set the maximum number of units of the product that can be purchased with the rebate, monitor the applications of the rebate in real-time and terminate the rebate immediately once the maximum number has been reached. Because the rebate (incentive 110) is verified and applied as soon as the consumer 102 submits the identifier 106, the chance to cause confusion is small.

After the incentive 110 is established, it may be sent to a party of a commercial transaction involving the commercial item. For example, if the incentive 110 is a rebate, a coupon or personal credit, it may be sent to the consumer 102. Sending the incentive 110 may only be for a purpose of notification, it therefore does not require all information of the incentive 110 to be sent, nor require the incentive 110 to play any functional role in the transaction. For example, a token representing the incentive 110 may be sent which only contains enough information to specify the commercial item 108 and the incentive value. The token may either be in a tangible form such as a printed medium or electronic such as a text message or multimedia message sent to a mobile phone.

The incentive 110 may be generated at the incentive module 210 in association with a user account of a party of a commercial transaction involving the commercial item. The incentive module 210 may send a token representing the incentive 110 to the party or another party of the commercial transaction who has an identification of the first party.

The incentive 110 may be a coupon, and this applied to the commercial item 108 by transferring a coupon value from an account of the business 122 or an authorized marketer promoting the commercial item to an account of the merchant 124 selling the commercial item 108.

The incentive 110 may be a rebate, and is applied to the commercial item 108 by transferring a rebate value from an account of the business 122 or in authorized marketer promoting the commercial item to an account of the consumer 102 who has bought the commercial item 108.

In some implementations, the incentive 110 is associated with consumer 102 purchasing the commercial item 108, and the incentive value of the incentive 110 is determined using a personalized score quantifying a contribution history and/or a loyalty history of the consumer acts in relation to the business 122 which makes or markets the commercial item 108. The relevant consumer acts include a user review about a product made or marketed by the business, receiving feedback on the user review, or purchasing a product made or marketed by the business 122.

At 510, the incentive module 210 receives the identifier 106 and/or a confirmation code thereof revealed to the authorized party. Usually, the authorized party is either the consumer 102 who has bought the item 108, or the merchant 124 who has sold the item 108.

For example, the complete identifier 106 (example identifier 400), including its confirmation code (example confirmation code 402c) if there is one, may be revealed to the consumer 102 who has bought the item 108. If the point-of-sale is an online shopping site and the purchase order is placed online to have the item 108 shipped to the consumer 102, the identifier 106 may not be sent to the server computer 116 until the consumer 102 has received the item 108.

The confirmation code, if there is one, may be received either as part of the complete identifier 106 at once or separately. For example, the consumer 102 may first use the personal computing device 104 (e.g., a smartphone) to scan and send an item identification code portion (e.g., barcode 401c) to the computer systems 116 and receive a prompt to enter the confirmation code (e.g., alphanumerical code 402c). This process may be accomplished using a special mobile application program installed on the smart phone.

Alternatively, the POS device 126 may acquire and send the identifier 106 to the server computer 116 for verification. For example, the POS device 126 may obtain a scan of a barcode encoding at least a part of the identifier 106 and transmits the scan to the server computer 116.

In one implementation, the identifier 106 may only be recognized by the merchant 124 and kept from the view of the consumer 102. The merchant 124 may send the identifier 106, along with an identification of the consumer 102 (e.g., a mobile phone number provided by the consumer 102 at the POS device 126), to the server computer 116 by using the POS device 126. For a heightened verification, server computer 116 may additionally send a confirmation code to the consumer 102, and request the confirmation code be returned to the server computer 116 in order to verify the identity of the consumer 102 who is at the point of sale purchasing the item 108.

In general, when the incentive 110 is generated in association with a consumer account 120 of the consumer 102 who is a party of a commercial transaction involving the commercial item 108, the incentive module 210 may require the identification of the consumer account be verified before applying the incentive 110. The identification of the consumer account may be a phone number associated with a mobile device of the consumer.

In general, the incentive module 210 may receive at least a first part of the identifier 106 and subsequently receive a second part of the identifier 106 as a confirmation to the first part. The first part and the second part may be received from different parties involved in the transaction. For example, the first part (e.g., barcode 401c) may be first received from the consumer 102 who is a buyer; and the second part (e.g., confirmation code 402c) may be received from the merchant 124 who is a seller to corroborate with the first part of the identifier 106 received from the consumer 102; or vice versa.

The transaction detection module 226 may help identify a transaction in which the consumer 102 purchases an item 108 from the merchant 124. The transaction may be identified by a consumer identifier that identifies the consumer and an item identifier 106 that identifies the item. The transaction may be detected by receiving a communication from a mobile device of the consumer or a POS device of the merchant. In some implementations, placement of the mobile device in proximity to a near field communication (NFC) sensor at the merchant may cause the NFC sensor to generate a signal which, when received by the communication interfaces 208, is interpreted by the transaction detection module 226 as indicating that a transaction has occurred. The NFC sensor may be an integrated part of a POS device or it may be a separate device that the merchant can add later without needing to update or modify existing POS infrastructure.

At 512, the incentive module 210 verifies the identifier 106 by matching the received identifier 106 against the records of the identifier 106 stored in data 119. If a confirmation code is also provided, the validity of the identifier 106 is further checked using the received confirmation code.

At 514, if the incentive module 210 fails to verify the identifier 106 received, it may reject the incentive 110 and optionally notifies the party or parties (the consumer 102 and/or the merchant 124).

At 516, responsive to successfully verifying the identifier, the inventive module 210 applies the incentive 110 to the commercial item 108, and optionally notifies the party or parties.

To apply the incentive 110 to the commercial item 108, the incentive module 210 may transfer the incentive value from an account of the business 122 or a marketer promoting the commercial item to the account of a party of a commercial transaction involving the commercial item.

To enhance security, the server computer 116 may credit a holding account with a payment based on the incentive value of the incentive 110, and only release the payment from the holding account after a confirmation condition is satisfied. Example confirmation conditions include verifying the identifier 106 using a confirmation code, verifying the purchase by requiring the consumer 102 to submit a purchase receipt, verifying the purchase by requiring the merchant 124 to submit a purchase receipt, verifying the payment for the purchase made through a payment system, conducting a random audit, etc.

Server computers 116 are used for enabling application of an incentive in a commercial transaction. As shown in FIG. 2, server computer 116 include a processing unit 202; memory 204 coupled to the processing unit 202; one or more communications interfaces 208, coupled to the processing unit 202, to receive an item identifier 106 that identifies a commercial item 108. The incentive module 210, stored in the memory 204 and executable on the processing unit 202, may include an incentive creation module (not shown) to generate an incentive having an incentive value applicable to the commercial item, and a transaction detection and verification module (not shown) to detect and verify a transaction involving the commercial item. The transaction is detected and verified based at least on the item identifier 106. The incentive module 210 may further have an incentive application module (not shown) to apply the incentive to the commercial item 108 in response to a successful detection and verification of the transaction. When the item identifier 106 comprises an item identification code and a confirmation code, and the transaction detection and verification module may be adapted to receive the item identification code and the confirmation code separately to detect the transaction based on the item identification code and to verify the transaction based on the confirmation code.

In one implementation, the transaction is verified based at least in part on a communication received from a mobile device 104 of a buyer, and a communication received from a POS device 126 of a seller. In some embodiments, a communication is received from a payment system or a funding source used to pay for the item.

The incentive determined at 512 may be a personalized price, a discount, a rebate, a coupon, or a credit for an item sold by the business. Accordingly, the business may desire a system that provides the greatest incentives and best “rewards” to the best consumers. Accordingly, reducing the score at 524 for consumes that have a low level of loyalty may support the business' goals. However, the business may also wish to foster a business and consumer social space in which productive energy is rewarded. Therefore, the business may recognize the value of knowledge contributions that help other consumers. Thus, knowledge contributions which receive poor peer feedback may have reduced their effect on a consumer's score reduced at 518. Both considerations may be combined and the quantification of a score for the consumer at 510 may depend on all three of the peer feedback from 514, the evaluation from the business at 508, and the loyalty metric at 520.

Intangible Identifier Generated on-the-Fly

FIG. 6 is an alternative to the example architecture of FIG. 1. Rather than using a tangible identifier 106 which is created prior to the transaction of selling and buying the item 108, an intangible identifier 606 is used as illustrated below. Other components and connectivity in the architecture of FIG. 6 are similar to that of FIG. 1.

FIG. 7 shows an example process 700 for fulfilling an incentive to a consumer on behalf of a business using intangible identifier generated on-the-fly. The process 700 is implemented on one or more computer systems for applying an incentive in a commercial transaction. The one or more computer systems are similar to that described in FIGS. 1-5.

At 702, the incentive module 214 of the server computer 116 receives augmented item information 605 related to the commercial item 108 from a POS device 126 at a point-of-sale of the merchant 124. The augmented item information 605 may include the product information related to item 108 such as a UPC or an SKU of the commercial item, or descriptive information of the commercial item 108. The augmented item information 605 may also include additional information such as the geographic location of the point-of-sale, IP address of the consumer 102, and the time of the transaction, etc.

At 704, the incentive module 214 generates an item identifier 606 which identifies the commercial item 108. The identifier 606 is created to uniquely identify the associated commercial item 108 among at least all commercial items active in the server computer during a desired operating period. The augmented item information 605 provides the bases for the server computer 116 to generate the item identifier 606, which has an enhanced level of specificity as compared to a regular product barcode. The dynamically generated item identifier 606 may be used as an actionable link between the item 108 and the consumer 102 to enable an improved incentive fulfillment process in a similar way as the tangible identifier 106 does as described herein.

At 706, the server computer 116 sends the identifier 606 or a confirmation code thereof to a first application program running at or in connection to the point-of-sale. This sets up a stage for further verification. As the system (server computer 116) now has not only the record of the item identifier 606, but also associates the identifier 606 with an ongoing transaction (which can be identified with a continuous session or any other suitable handles in the system), it may not need to send the complete identifier 606, but instead just send a short confirmation code which is associated with the identifier 606. As described herein, the transaction detection module 226 may help identify the transaction in which the consumer 102 purchases an item 108 from the merchant 124. The relationship between the confirmation code and the identifier 606 may be similar to that of confirmation code 402c and the item identifier 400 as described herein, except that here the identifier 606 only takes a digital form and is not physically embodied on the item 108 or another accessory item.

At 710, the incentive module 214 of the server computer 116 receives the identifier 606 or the confirmation code thereof from a second application program running at or in connection to the point-of-sale.

At 712, the incentive module 210 verifies the identifier 606 by matching the received identifier 606 or the confirmation code against the records of the identifier 106 or the confirmation code stored in data 119.

At 714, if the incentive module 210 fails to verify the identifier 606, it may reject the incentive 110 and optionally notifies the party or parties (the consumer 102 and/or the merchant 124).

At 716, responsive to successfully verifying the identifier 606, the inventive module 210 applies the incentive 110 to the commercial item 108, and optionally notifies the party or parties.

There are a variety of ways to take advantage of the unique item identifier 606 generated in the system to instantly verify the commercial transaction and apply incentive 110 associated with the item 108 involved in the transaction.

In one implementation, the augmented item information 605 is received at the server computer 116 from a device of the seller (the merchant 124); the first application program runs on the device of the seller, while the second application program runs on a device of the buyer (the consumer 102). For example, the POS device 126 acquires and sends the augmented item information 605 to the server computer 116, which generates the item identifier 606 and sends it back to the POS device 126, which then transfers the item identifier 606 or only a confirmation code thereof to the consumer 102. For example, the POS device 126 may simply display the identifier 606 or its confirmation code on the screen. The consumer 102 uses the personal computing device 104 (e.g., a mobile phone) to acquire the item identifier 606 or the confirmation code and sends it to the computer systems 116 for verification. If the entire item identification code 606 is transferred from the POS device 126 to the personal computing device 104, it may preferably be embodied in the machine-readable form, such as a scannable 2-D barcode, or NFC readable code. However, only a short confirmation code of the identifier 606 may need to be acquired by the consumer 102, especially if the POS device 126 has identity information of the consumer 102 and has further communicated the identity information in association with the current transaction to the server computer 116. The consumer 106 may pass the identity information (such as a registered mobile phone number) to the POS device 126 in a variety of ways including but not limited to manual input, card swipe, wireless communication such as Bluetooth, and NFC. In this case, the consumer 102 may just manually enter the short confirmation code, which preferably has a length of six alphanumerical digits or shorter. This process can be done using a special mobile application installed on the mobile phone of the consumer 102.

The above example is also applicable to a situation where the point-of-sale is an online shopping site, and the POS device 126 refers to a server instance (not shown) of the merchant 124 running a POS program to render an online checkout user interface to a POS client program on a device of the consumer 102. As used herein, in this case the POS device 126 is considered a device of the seller (the merchant 124) even though the online checkout user interface is displayed on a device of the buyer (the consumer 102). For example, the merchant server (not shown) running the online POS sends augmented item information 605 to the incentive module 210 of the computer systems 116, which generates the identifier 606 and sends the identifier 606 back to the merchant server, which then transmits the identifier 606 to the POS client program on the personal computing device 104 of the consumer 102. The consumer 102 captures the identifier 606 using a mobile phone (not shown). The identifier 606 may be displayed as a machine-readable barcode through the POS client program on the personal computing device 104, and captured by the consumer 102's mobile phone, which then sends the captured identifier 606 back to the server computer 116 using a mobile application on the mobile phone for verification. In one implement, the personal computing device 104 and the mobile phone are the same device but has two separate application programs running, one being the POS client program of the merchant server to render a POS user interface, the other being a mobile application communicating with the server computer 116 to facilitate the application of the incentive 110.

In an alternative implementation, the augmented item information 605 is received from a device of the seller (the merchant 124); that first application program runs on a device of the buyer (the consumer 102), while the second application program runs on the device of the seller. For example, the POS device 126 acquires and sends the augmented item information 605 to the server computer 116, which generates the item identifier 606 and sends it the personal computing device 104 (e.g., a mobile phone), which then transfers the item identifier 606 or only a confirmation code thereof to the POS device 126. The transfer may be accomplished using a scanner of the POS device 126, wireless communication, NFC or manually. The consumer 102 uses the personal computing device 104 (e.g. a mobile phone) to acquire the item identifier 606 or the confirmation code and sends it back to the computer systems 116 for verification.

To further heighten the security, the incentive module 210 may require receiving from a payment system an indication that a payment has been made at the point-of-sale with regard to the commercial item 108, and use the receipt of such indication as a condition for applying the incentive to the commercial item. Depending on the type of point-of-sale, the server computer 116 may have a different relationship with the payment system. If the merchant 124 is an independent entity from the owner of the server computer 116, the payment system is likely a third-party system and needs to be separately connected to the incentive module 210. This is the case whether the POS device 126 is at a brick-and-mortar store or on a server supporting online shopping. In an alternative embodiment, the POS device 126 is either part of or integrated with the sales module 236 of the server computer 116, and the payment module 228 is either part of or integrated with the payment system used by the POS device 126. In this embodiment, indication or evidence of the payment event may be more readily obtained.

The POS device 126 may be a tablet computing device which has a customer checkout application program installed thereon. The customer checkout application may be either the first application program that receives the identifier 606 from the server computer 116 or the second application program that returns the identifier 606 to the server computer 116. The application program on the tablet computing device may interface with the incentive module 210 through a set of API.

The POS device 126 may be a self-checkout device. The server computer 116 sends the identifier 606 to the self-checkout device, and receives the identifier 606 returned from the personal computing device 104 (e.g., a mobile device) of the consumer 102 using the self-checkout device. Alternatively, the server computer 116 sends the identifier 6062 to the mobile device of the consumer 102 who is using the self-checkout, and receives the identifier 606 from the self-checkout device.

In one implementation, the server computer 116 sends the identifier 606 to a mobile device of the consumer 102, and receives the identifier or the confirmation code from a client program of an online shopping website through the mobile device or a separate personal computing device such as a personal computer. When the same mobile device is used for both receiving and sending back the identifier 606, the mobile device preferably receives the identifier 606 by using an application program separate from the client program of the online shopping website to ensure the integrity of the loop.

In general, as long as there are two application programs running at or in connection to the point-of-sale to form a loop of information for verification by transmitting the identifier 606 to and from the server computer 116, there is no restriction as to the specific way to implement the loop. As used herein, “running at or in connection to the point-of-sale” does not suggest the application program belongs to the point-of-sale or installed on the POS device.

As described herein, depending on the connection session status and the server computer 116's knowledge of the identity of the consumer 102, the verification loop may not need the transmission of the entire identifier 606 but instead only need to transmit a short confirmation code of the identifier 606.

The point-of-sale may be a brick-and-mortar retail store, an online shopping website of one or more registered businesses, a hybrid shopping site combining off-line and online ordering, or an online shopping website supported by the sales module 236 of the server computer 116 which also has an incentive module 210. The point of sale may or may not be connected to the incentive center, and when connected may or may not be fully integrated in the same system.

### Intermediary Account System

The personal incentives provided to productive consumers may include non-monetary benefits such as the status of guru or expert and the esteem of other members of the community. However, many of the strongest incentives may be personal pricing or discounts on items sold by the merchants. Realizing the personal pricing closes the feedback loop between consumers and business. Once the personal price or discount amount is identified, that incentive may be provided to the consumer using any technique including paper coupons that are passed of the consumer to a clerk at the merchant. However, to provide the greatest convenience and integration of this social network into the interactions between the consumers and merchants, it is desirable to make implementation of the personal incentives as effortless and transparent as possible. It is also desirable to allow consumers to access their personal pricing at merchants that are not members of this network (e.g., when the business that makes the item provides the incentive and the retailer does not participate in this system).

In some implementations, the entity providing the personal incentive for personal pricing may be different than the entities involved in the transaction. For example, a business that manufactures and item may wish to reward a consumer for his or her brand loyalty but the consumer may buy the item from a merchant that is different from the business that manufactures the item. Thus, if there is a pricing difference between the base price that the merchant offers the item and the personalized price that is available to the consumer due to the incentive provided by the business there is a need to make sure that the consumer is able to access his or her incentives provided by personalized pricing. This may be done by providing the consumer with a coupon or a rebate. If the consumer is using a coupon the merchant may need to request reimbursement for the value of the coupon. It is the opposite for a rebate because the consumer then has the burden of submitting the rebate. In each situation there is an entity that wishes to receive money and there is a need to protect against fraudulent or inaccurate submissions.

In addition to, or alternative to, the verification loop using a verifiable item identifier (such as the identifier 106, the identifier 606), the personalized incentives may be implemented using an intermediary account system that includes accounts for the merchants and the consumers which are part of this social space. With the intermediary accounts the members of this community may exchange funds using deposit accounts that can be shared with traditional bank accounts but are also part of this system. In some implementations, funds may be held in escrow account and released to a deposit account only when certain conditions have been confirmed. The intermediary account system may also be used for facilitating transactions between consumers and merchants without providing an escrow function.

The intermediary account system may be implemented by the server computer 116 introduced in FIG. 1. Returning to the description of the server computer 116 in FIG. 2, several modules from the memory 204 are particularly relevant to implementing an intermediary account system. The personal pricing module 216 may determine a personal price for the item that is specific to the consumer. In some implementations the personal price is a function of the consumer's score. For example, the personal price may be based on reviews of knowledge contributions provided by the consumer. The knowledge contributions that affect the personal price of an item may be only those knowledge contributions that are associated with the item such as reviews of similar items, items from the same business, items of the same brand, etc. The reviews of the consumer's knowledge contributions may be made by other consumers, merchants, and/or businesses.

As described herein, the transaction detection module 226 may identify a transaction in which the consumer purchases an item from the merchant.

The consumer identifier and/or the item identifier may be received by the communications interfaces 208 and receiving these identifiers may itself serve as an indication that a transaction has occurred. In some cases, the consumer identifier may be received from the mobile device of the consumer or alternatively from the POS device of the merchant. Similarly, the item identifier may be received from either the mobile device of the consumer or the POS device of the merchant. For transactions conducted at a traditional brick-and-mortar retail location that has a network-enabled POS device, the consumer identifier may be received from the POS device. If the consumer is making a purchase from his or her mobile device, both the item identifier and the consumer identifier may be received from the mobile device.

A payment module 228 may provide a payment for a difference between a base price of the item and the personal price of the item. Depending on how the transaction is implemented, the payment may be made to the consumer or to the merchant. For example, if the consumer presents a coupon to the merchant and the merchant only receives the lower, personal price from the consumer then the merchant may submit the coupon in order to receive a reimbursement for the difference. Alternatively, if the consumer pays the base price which is more than the personal pricing for that consumer, the payment may be provided as a rebate to the consumer.

The escrow account module 230 may make the payment for the difference between the base price of the item and the personal price of the item into an escrow account and release the payment from the escrow account after receiving confirmation of the purchase. Depending on the technique used reduce the base price of the item, the escrow account may be an account of the consumer or an account of the merchant. Confirmation of the purchase may come from a payment source such as a credit card of the consumer, self reporting by the consumer such as submitting a copy of a receipt, or by reporting from the merchant.

The verification module 232 may provide confirmation of the purchase. This confirmation may be used to release the payment from the escrow account. The confirmation may be based on a communication received from the mobile device of the consumer or a communication received from the POS device of the merchant. For example, the consumer may take a photograph of a receipt with his or her mobile device and submit the image as confirmation of the purchase. If the POS device is connected to the network, transactions may be sent to the server computer 116 in essentially real time as the transactions are processed. If, however, POS devices at the merchant are not directly in communication with the server computer 116, the merchant may use a separate device that has a wired or wireless connection to the network in order to submit transaction confirmations to the verification module 232. This separate device, a verification device, may be wholly separate from and lack a communicative connection to the POS device. For example, the verification device may simply communicate a merchant identifier and possibly a timestamp each time a button is pressed on the verification device or each time a mobile device is bumped against the verification device. The basic data provided by the verification device may be used to double check confirmation information provided by the consumer. Additionally, a communication from a funding source used to pay for the item, such as a credit card company or a mobile payment processor, may be received by the verification module 232 as evidence that consumer purchased the item from the merchant.

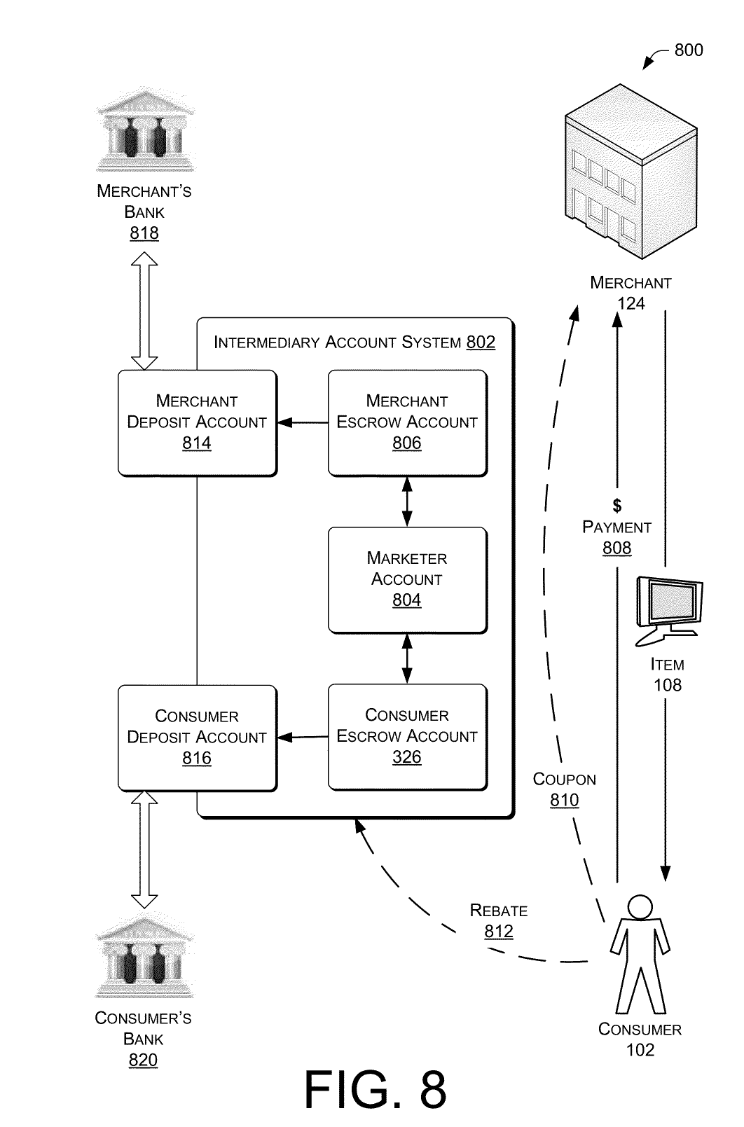

FIG. 8 shows an example architecture 800 of the intermediary account system 802. The intermediary account system 802 may use a marketer to implement the personal incentives for the consumer 102. The marketer may be the business 128 shown in FIG. 1 that manufactures, assembles, distributes, imports, or is otherwise connected with the item 108. However, the marketer may also be a third-party that assists in providing payments in order to affect personal pricing in a way that is fair to both the consumer and the merchant 124. The marketer may have a marketer account 804 in the intermediary account system 802 from which the marketer can make payments to an account of the consumer 102 and/or an account of the merchant 124. In some implementations, the marketer account 804 may be the same as the business account 306.

The payment 808 by the consumer 102 for the item 108 may or may not reflect the personal pricing for the consumer 102 that is available on that item 108. If the merchant 124 is using a POS device that is connected to the server computer 116 implementing the social network described above, the POS device may be able to obtain the personal pricing and use of the intermediary account system 802 may be unnecessary. However, the intermediary account system 802 provides a convenient way to implement personal pricing for merchants that do not have networked POS devices or merchants that are not part of this business and consumer social space.

Assuming that the personal pricing is not automatically acquired by the POS device, the consumer 102 may obtain his or her personal pricing by submitting a coupon 810 to the merchant 124 and paying a lower price at the time of sale or by paying the regular price to the merchant 124 and then later submitting a rebate 812 for reimbursement.

In both cases the marketer desires to make payments for the coupon 810 or the rebate 812 only if the specified item 108 is sold by the merchant 124 to the consumer 102. In order to prevent fraud and provide time for confirmation, initial payments may be made from the marketer account 804 to the merchant escrow account 806 (for coupons 810) or to the consumer escrow account 326 (for rebates 810). Funds in the respective escrow accounts 806 and 326 are released for use once the marketer has received sufficient confirmation of the transaction. Thus, the consumer 102 and the merchant 124 may be able to see the effects of submitting a coupon 810 or rebate 812 to the marketer relatively quickly, but the marketer may be able to have sufficient time to claw back funds from the escrow accounts 806 and 326 in the event of fraud or a mistake.

The intermediary account system 802 may also include a merchant deposit account 814 and a consumer deposit account 816 from which the merchant 124 and the consumer 102 respectively may freely add or withdraw funds without conditions imposed by the marketer. If the intermediary account system 802 is also used to facilitate payment 808 for the item 108, the payment 808 may move from the consumer deposit account 816 to the merchant deposit account 814. Thus, the intermediary account system 802 may function as a payment system in parallel to functioning as a system at effectuates personal pricing. Also, in implementations that do not include the security level of an escrow account, payments from the marketer account 804 for coupons 810 or rebates 812 may be made directly to the merchant deposit account 814 and/or the consumer deposit account 816.

The merchant deposit account 814 may exchange funds with the merchant's bank 818 or with any other financial account of the merchant 124. Similarly, the consumer deposit account 816 may exchange funds with the consumer's bank 820 or with any other financial account of the consumer 102. The merchant deposit account 814 and the consumer deposit account 816 are part of the intermediary account system 802, but the use of these accounts 814 and 816 is not limited to transactions that are facilitated by the intermediary account system 802. Both the merchant 124 and the consumer 102 may use their respective merchant deposit account 814 and consumer deposit account 816 like any other financial account to make and receive payments even when those payments are not connected to the business and consumer social space.

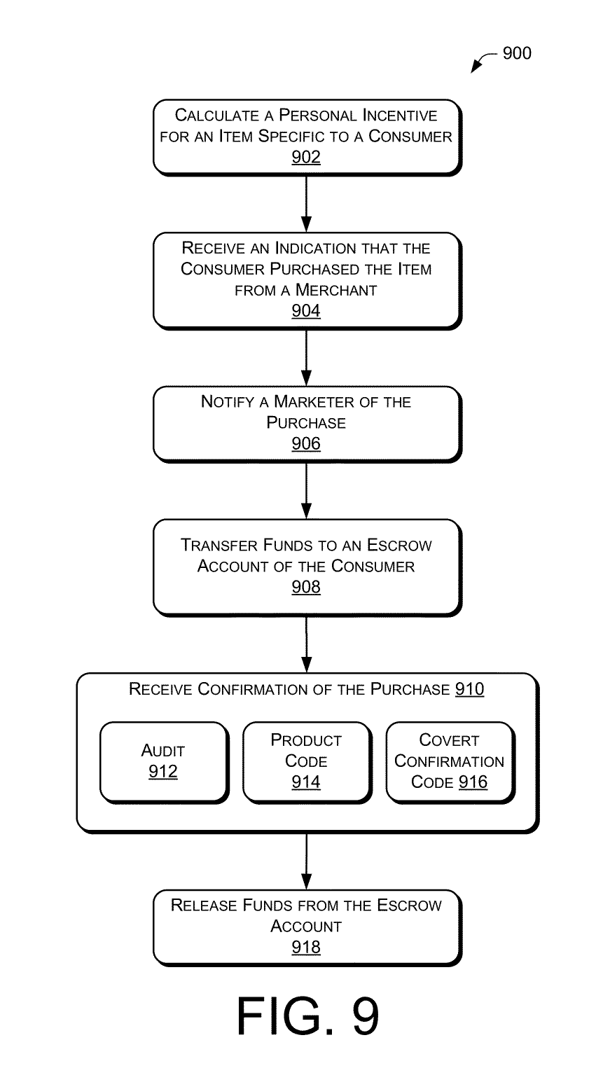

FIG. 9 shows an example process 900 for affecting a personal price using a rebate mode. As shown, unlike the traditional rebate process which requires submission of a physical rebate with purchase evidence for each individual item purchased by the consumer, the personal incentive-based rebate in accordance with the present disclosure is either instant or semi-instant with immediate rebate redemption pending a conditional affirmation.

At 902, a personal incentive is calculated for an item. The personal incentive may be in the form of a personal price or a personal discount, rebate or credit to effectuate a personal price. The personal incentive or the personal price is specific to a consumer and based on reviews of previously generated knowledge contributions created by the consumer. The reviews of the consumer's knowledge contributions may affect the price such that relatively more favorable reviews correlate with a relatively lower personal price. The personal pricing module 216 may calculate the personal price.

At 904, an indication that the consumer has purchased the item from a merchant is received. The transaction detection module 226 may receive the indication.

At 906, a marketer is notified of the purchase. The marketer is responsible for modifying the transaction between the consumer and the merchant to effectuate the personal price by issuing the consumer a rebate. By modifying the transaction with a rebate the effects of the personal pricing are transparent to the merchant. Receipt of a rebate request from the consumer may be the notification of the purchase that is received by the marketer. In some implementations, the consumer may submit the rebate from a mobile device when he or she makes the purchase at the merchant. Sending notification to the marketer is optional. The marketer may pre-authorize the system to conduct the personal incentivization according to pre-agreed terms.

At 908, in response to receiving the indication of purchase funds are transferred from an account of the marketer to an escrow account of the consumer in order to compensate the consumer for the rebate. For example, if the consumer purchased an item at a price that was $10 above his or her personal price for that item the consumer can submit the rebate and receive $10 in his or her escrow account.

At 910, confirmation that the consumer has indeed purchased the item from the merchant is received. The confirmation may take any form that is satisfactory to the marketer or conditions preagreed to by the marketer.

For example, at 912 the confirmation comprises an audit performed after the consumer submits the rebate. The audit may be performed randomly on a small percentage (e.g., 1% or 0.1%) of all transactions to achieve a balance between fraud deterrence and customer convenience. Therefore, the vast majority of customers will be able to obtain and use their rebates immediately. The social aspect of this system may also discourage fraud because fraud could cost the consumer any future discounts and even “earn” the consumer a higher personal price than the regular price. The audit may use the mobile device of the consumer and require the consumer to take a picture of a receipt from the purchase and submit the image to the marketer. The audit may also be performed immediately after the purchase is completed so that the consumer will be unlikely to have lost the receipt, the packaging barcode, or other evidence of the purchase.

At 914, the confirmation may be a product code that is received from the consumer. The product code may be one like the item identifier 106 or 606, or a part thereof (e.g., the product item identification code portion exemplified by the barcode 401c). The product code may be a code such as a universal product code (UPC) that uniquely identifies the item or the code may be something like a serial number that distinguishes each unit of the item from other units of the same item. The consumer may observe this code and enter it into his or her mobile device for transmission to the marketer. Computing systems of the marketer may record each submission and by doing so prevent the product code for a specific unit of the item from serving as confirmation for more than one transaction. This allows only one-time verification.

At 916, confirmation may be achieved by receiving a covert confirmation code from the consumer. The covert confirmation code confirms an overt product code. Like the product code 914, the overt product code may uniquely identify the item by distinguishing each unit of the item from other units of the same item. The covert product code may be covered by a scratch-off material, located inside product packaging, or otherwise concealed in a way that can be revealed by the consumer after purchasing the product. This may ensure that rebate submissions are received only from products that the consumer has purchased.

The product code or the covert confirmation code may be a combination of both an overt product item identification code and a covert verification code. The covert verification code may be verifiable by the marketer, but remain concealed from the consumer. This technique thwarts fraudulent creation and submission of confirmation codes because the fraudulent confirmation codes will lack the necessary verification code.

At 918, funds are released from the escrow account of the consumer in response to receiving satisfactory confirmation at 910.

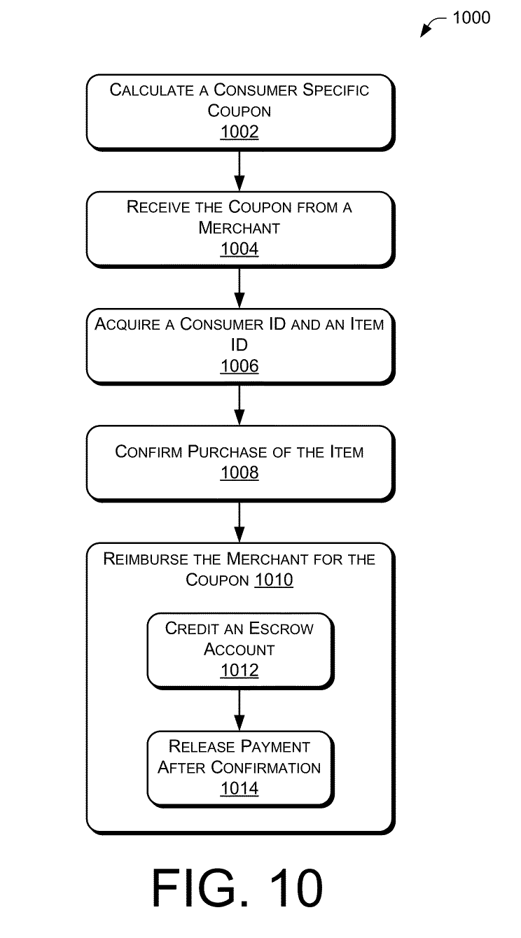

FIG. 10 shows an example process 1000 for provisioning a personal incentive to a consumer by using a coupon. At 1002, a coupon is calculated for an item. The coupon is specific to the item and to the consumer. The coupon may be general or personalized based on reviews of previously generated knowledge contributions created by the consumer. Relatively more favorable reviews (e.g., indicating that the consumer generated “better” knowledge contributions) may correlated with a relatively more valuable coupon (i.e., a larger discount).

The previously generated knowledge contributions may be related to items that belong to a predefined item category and the item that the consumer intends to purchase with the coupon may also belong to the same predefined item category. Thus, the item that can be purchased with the coupon “matches” the categories of items in the knowledge contributions. For example, if the knowledge contributions are about bicycles or products for use with bicycles, then the coupon would be application to an item that is associated with bicycles, but not with another category of item such as a digital camera.

At 1004, the coupon is received from a merchant. The merchant may receive the coupon from the consumer as a slip of paper, a code, a user name, an identifier of a mobile device of the consumer or the like. The merchant will sell an item to the consumer at a price determined by the coupon and (assuming the marketer of the coupon is a different entity than the merchant such as the business 128 shown in FIG. 1) the merchant will request reimbursement for the value of the coupon.

At 1006, a consumer identifier of the consumer and an item identifier of the item are acquired. These two identifiers allow computer systems to readily identify the “who” and the “what” of the transaction. Since coupons (and personal pricing in general) is specific to a given consumer and specified item, acquiring these two identifiers is useful for determining the proper coupon to apply to the transaction. The consumer identifier may be the consumer identifier 305 shown in FIG. 3.

The transaction between the consumer and the merchant may be implemented by a POS device of the merchant, a mobile device of the consumer, or both. Thus, the consumer identifier and the product identifier may come from either of those devices.

In other implementations, such as at a merchant location that lacks POS devices or that has POS devices which are not connected to the same network as the marketer, the consumer's mobile device may be used to submit both the consumer identifier and the item identifier. For example, the consumer may take a picture of the item or of a barcode on the item and submit the image to the marketer. The system on the mobile device may automatically append the user identifier to the submission.

At 1008, the purchase of the item is confirmed by referencing the consumer identifier and the item identifier. Examples of a suitable method for confirming a purchase of an item 108 identified by the item identifier 106 are disclosed herein with FIGS. 1-7. In addition, the purchase may be confirmed by locating the consumer identifier and the item identifier in sales records sent periodically from the merchant to the marketer. The sales records may be sent in batches daily, weekly, etc. The sales records may be sent in any form including non-digital forms such as paper records.

A device under control of the consumer, such as the mobile device or another computing device, may provide confirmation by sending the consumer identifier and/or the item identifier. Since the consumer has already received the benefit of the coupon, he or she has less incentive to make a fraudulent submission than the merchant and confirmatory data sent from the consumer may be deemed sufficient to confirm the transaction.

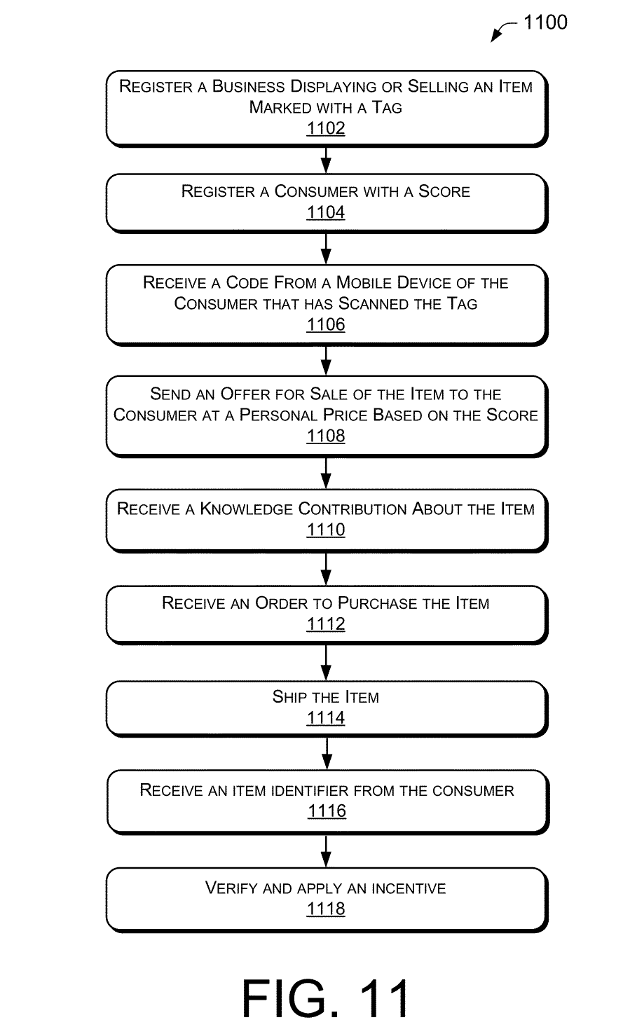

At 1010, the merchant is reimbursed for the coupon in response to the confirmation of the purchase. The merchant may be reimbursed by receiving, at 1012, a credit to an escrow account. The escrow account may be the escrow account 306 shown in FIGS. 3 and 11. The merchant may receive a payment to the escrow account based on the value of the coupon. The payment may be for slightly more than the value of the coupon to compensate the merchant for its processing expenses. The payment to the escrow account may be made immediately upon receipt of the coupon even before verifying the validity of the coupon.

At 1014, payment is released from the escrow account of the merchant after confirming that the consumer has purchased the item. The purchase may be confirmed by any of the techniques described above.

### Hybrid Shopping Combining Off-Line and Online Elements

The item identifier (e.g., identifier 106 or 606) enables a unique hybrid shopping model that combines off-line and online elements. A manufacturer or marketer may set up a physical storefront where the product items are displayed or demoed. The consumer visits the demo storefront to browse and learn about the product items and place an order online to have the purchased item shipped to the consumer. Referring to FIG. 1, the manufacturer or marketer may be the business 122, a marketing company that is registered at the server computer 116, or a business entity that operates the server computer 116.

FIG. 11 shows an example process 1100 for hybrid shopping with auto fulfillment of verifiable incentives. Process 1100 may be implemented in part by the sales module 236.

The illustrated example process sends an offer to sell an item to the consumer when the consumer scans a machine-readable tag associated with a display or demo item. However, the offer to sell may be triggered by any suitable method. For example, a POS device may be placed at the demo storefront to offer an interactive online shopping user interface for the consumer to place orders. A cloud POS may be used to enable an interactive online shopping user interface on a mobile device of the consumer to place and receive orders.

At 1102, a business displaying or selling an item at a brick-and-mortar location is registered. The registration may include creating a business account 302 for the business as store shown in FIG. 3. The item that is being sold may be marked with a machine-readable tag encoding information that identifies the item as well as potentially including additional information about the item.

At 1104, a consumer is registered. Registering the consumer may include creating a consumer account 303 for the consumer in the consumer accounts 120 data store shown in FIG. 3. The consumer is associated with a score, such as the consumers score 320, that is based on past actions of the consumer in relation to the business. For example, the past actions may include purchasing items from the business, generating knowledge contributions about items sold by the business, and scanning tags associated with the business.

At 1106, a code is received from a mobile device (an example of the personal computing device 104) of the consumer in response to the mobile device scanning the machine-readable tag that is marking the item. The code may be received by the communication interfaces 208 of the server computer 116. The code received from the mobile device includes information encoded in the machine-readable tag and an identifier of the consumer. The identifier of the consumer may be obtained from the memory of the mobile device. Information that is encoded in the machine-readable tag may be processed by the decoding module 234.

At 1108, an offer for sale of the item or a related item is sent to the mobile device. The server computer 116 may send the offer directly by using the sales module 236 or the server computer 116 may contact the business or another merchant and instruct a third party to send the offer for sale to the mobile device. The offer for sale may indicate an incentive (such as the incentive 110). The incentive may be a general marketing offer to any potential buyer, or an embodiment of a personal price that is based on the score of the consumer 102. In this case, the price is personal to the consumer 102 and may be calculated, as discussed above, by the personal pricing module 216.

In some implementations the business displays an item for sale but does not offer the item directly for sale from the brick-and-mortar location. The brick-and-mortar location may function as a showroom or display area for items that are representative of the inventory of the business. The consumer may interact with the representative items and learn about features available in different items that are not shown at the brick-and-mortar location. Thus, the tag on one item may provide an opportunity to purchase a different unit of the same item or a unit of a similar but not identical item. The item and the related item may be related by belonging to the same category of items such as brand, manufacture, or item function.

At 1110, a knowledge contribution about the item is received from the consumer. This offers an optional opportunity to receive the knowledge contribution from the mobile device when the mobile device and the consumer are still located at the business. However, it is noted that the knowledge contribution may be either generated by the consumer based on the consumer's experience with the item after he or she has purchased the item (and sent from any other computing device accessible by the consumer) or based on the consumer reviewing the item at the business. The knowledge contribution may be automatically stored in association with an identifier that identifies the item. The knowledge contribution capture module 212 may be responsible for receiving a knowledge contribution and storing the knowledge contribution. In some implementations, the knowledge contribution may be stored as part of the consumer account 303.

At 1112, an order is received from the mobile device to buy the item or the related item at the personal price. The user may scan the tag on the item and place an order from his or her mobile device to buy that item or the related item. If the business is designed as a showroom which is not intended to sell items from an on-site inventory, the business may simply provide demonstration items with tags and rely on consumers using their own mobile devices to process online purchases of items. Thus, the business may operate without a POS device on premises. Alternatively, however, a POS device, or the terminal device access and a cloud POS device, may be placed in the showroom for the consumer to place online orders of the item.

At 1114, the item or the related item may be shipped to the consumer. The business itself may do the shipping or it may instruct another party such as a shipping company to ship the item. Shipping the item to the consumer may allow the consumer to receive the item without having to provide the consumer a unit from inventory at the brick-and-mortar location.

At 1116, the server computer 116 receive an item identifier (e.g., the item identifier 106) from the consumer will has bought and received the item. If the item is shipped, this will occur after the consumer has received the item. Examples of the item identifier and processes of using the item identifier to validate the purchase and a related incentive are illustrated herein in FIGS. 1-7.

At 1118, the incentive module 210 of the server computer 116 verifies the item identifier received and applied an incentive.

Both physical identifies (like the identifier 106) and intangible identifiers (like the identifier 606) may be used in the process 1100. In case where an intangible identifier like the identifier 606 is used, the identifier may be dynamically generated on-the-fly when the consumer places the order at the point-of-sale. As described herein, depending on whether the incentive is a coupon, a rebate or a credit, a different process may be used for purchase verification and incentive application. For example, if the incentive is a rebate, the item identifier or a confirmation code thereof generated at the point-of-sale may be sent to the consumer either directly to the mobile phone of the consumer or indirectly through the POS device at the point-of-sale, if there is one.

### CONCLUSION

These processes discussed above are each illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method implemented on one or more computer systems for applying an incentive in a transaction involving a commercial item, the one or more computer systems including a server computer supporting an incentive module, the method comprising:
associating the commercial item with an identifier, the identifier being created to uniquely identify the commercial item among at least all commercial items active on the server computer during a desired operating period, and being affixed to or embedded in the commercial item or an accessory item associated therewith, wherein at least a portion of the identifier is covered from normal viewing and only conditionally revealed to an authorized party during or after the transaction;
establishing, at the server computer, an incentive having an incentive value applicable to the commercial item;
receiving, at the server computer, the identifier revealed to the authorized party;
verifying, at the server computer, the received identifier; and
responsive to successfully verifying the identifier, applying the incentive to the commercial item.

2. The method of claim 1, wherein the identifier comprises an item identification code and a confirmation code, and wherein the confirmation code is included in a covert portion of the identifier and, when revealed, is usable for confirming the item identification code.

3. The method of claim 1, wherein revealing the portion of the identifier covered from normal viewing causes an irreversible and visible change to the commercial item or the accessory item.

4. The method of claim 1, wherein receiving, at the server computer, the identifier revealed to the authorized party comprises:
receiving at least a first part of the identifier from a first party of the transaction; and
receiving at least a second part of the identifier from a second party of the transaction to corroborate with the first part of the identifier received from the first party, at least one of the first party and the second party being the authorized party.

5. The method of claim 1, wherein applying the incentive to the commercial item comprises transferring the incentive value of the coupon from an account of a marketer promoting the commercial item to an account of a party of the transaction.

6. The method of claim 1, wherein the incentive is associated with a consumer purchasing the commercial item, and the incentive value is determined using a personalized score quantifying a contribution history and/or a loyalty history of the consumer's acts in relation to a business which makes or markets the commercial item, the acts including writing a user review about a product made or marketed by the business, receiving feedback on the user review, or purchasing a product made or marketed by the business.

7. The method of claim 1, wherein receiving, at the server computer, the identifier revealed to the authorized party comprises receiving, from at least one of a POS device of the merchant selling the commercial item and a mobile device of a consumer buying the commercial item, a scan of a barcode encoding at least a part of the identifier.

8. The method of claim 1, wherein applying an incentive to the commercial item comprises:
crediting a holding account with a payment based on the incentive value; and
releasing the payment from the holding account after a confirmation condition is satisfied.

9. The method of claim 1, wherein establishing the incentive applicable to the commercial item comprises:
applying a marketing policy to the identifier, the marketing policy including rules for determining the incentive value at least partially according to one or more of factors including time of the transaction, a cumulative number of transactions involving similar commercial items, geographic location of the transaction, and identity of one or more parties involved in the transaction.

10. A computing device for enabling application of an incentive in a transaction, the device comprising:
a processing unit;
memory coupled to the processing unit;
one or more communications interfaces, coupled to the processing unit, to receive an item identifier that identifies a commercial item, the identifier being created to uniquely identify the commercial item among at least all commercial items active on the server computer during a desired operating period;
an incentive creation module, stored in the memory and executable on the processing unit, to generate an incentive having an incentive value applicable to the commercial item;
a transaction detection and verification module, stored in the memory and executable on the processing unit, to detect and verify a transaction, wherein the transaction is detected and verified based at least on the item identifier; and
an incentive module, stored in the memory and executable on the processing unit, to apply the incentive to the commercial item in response to a successful detection and verification of the transaction.

11. The device of claim 10, wherein the item identifier comprises an item identification code and a confirmation code, and the transaction detection and verification module is adapted to receive the item identification code and the confirmation code separately to detect the transaction based on the item identification code and to verify the transaction based on the confirmation code.

12. A method implemented on one or more computer systems for applying an incentive in a transaction involving a commercial item, the one or more computer systems including a server computer having an incentive module, the method comprising:
receiving information related to the commercial item from a business entity making, supplying, marketing or selling the commercial item;
generating an identifier of the commercial item, the identifier being created to uniquely identify the associated commercial item among at least all commercial items active on the server computer during a desired operating period;
sending the identifier to a receiving end authorized by the business entity to be affixed to or embedded in the commercial item or an accessory item associated therewith, wherein the identifier has at least a covert portion which is covered from normal viewing and only conditionally revealed to an authorized party during or after the transaction;
receiving, at the server computer, the identifier revealed to the authorized party;
verifying, at the server computer, the received identifier; and
responsive to successfully verifying the identifier, applying an incentive having an incentive value to the commercial item.

13. The method of claim 12, wherein the identifier comprises an item identification code and a confirmation code for confirmation thereof, the confirmation code being included in a covert portion of the identifier.

14. The method of claim 12, wherein revealing the portion of the identifier covered from normal viewing causes an irreversible and visible change to the commercial item or the label.

15. The method of claim 12, wherein the identifier is placed on a label or tag associated with the commercial item, wherein the portion of the identifier covered from normal viewing is covered by an irreversibly removable material.

16. The method of claim 12, wherein the identifier has a longer code and a shorter code both placed on one or more labels or tags associated with the commercial item, the shorter code being covered by an irreversibly removable material and serving as a confirmation code of the identifier.

17. A method implemented on one or more computer systems for applying an incentive in a transaction involving a commercial item, the one or more computer systems including a server computer having an incentive module, the method comprising:
receiving, at the server computer, augmented item information related to the commercial item from a point-of-sale;
generating, at the server computer, an identifier of the commercial item based on the augmented item information, the identifier being created to uniquely identify the associated commercial item among at least all commercial items active on the server computer during a desired operating period;
sending the identifier or a confirmation code thereof to a first application program running at or in connection to the point-of-sale;
receiving, at the server computer, the identifier or the confirmation code from a second application program running at or in connection to the point-of-sale;
verifying, at the server computer, the received identifier or the confirmation code; and
responsive to successfully verifying the identifier or the confirmation code, applying an incentive to the commercial item.

18. The method recited in claim 17, wherein the augmented item information is received from a seller's device, the first application program runs on the seller's device, and the second application program runs on a buyer's device.

19. The method recited in claim 17, wherein the augmented item information is received from a seller's device, the first application program runs on a buyer's device, and the second application program runs on the seller's device.

20. The method recited in claim 17, further comprising:
receiving, at the server computer, from a payment system an indication that a payment has been made at the point-of-sale with regard to the commercial item, receiving the indication being a condition for applying the incentive to the commercial item.

21. The method of claim 17, wherein the point-of-sale comprises a tablet computing device which has a customer checkout application program installed thereon, the customer checkout application being one of the first application program and the second application program, interfacing with the incentive module through a set of API.

22. The method of claim 17, wherein the point-of-sale comprises an online shopping website.

23. The method of claim 17, wherein sending the identifier or the confirmation code thereof to the first application program comprises sending the identifier or the confirmation code to an online shopping website of a merchant to be displayed to a consumer buying the commercial item; and receiving the identifier or the confirmation code from the second application program comprises receiving the identifier or the confirmation code from a mobile device of the consumer.

24. The method of claim 17, wherein the augmented item information comprises one or more of a UPC, an SKU of the commercial item, information descriptive of the commercial item, and information indicative of time or a location.
